(19) United States
(12) Patent Application Publication
(10) Pub. No.: US 2021/0368789 A1
(43) Pub. Date: Dec. 2, 2021

(54) STIMULATION OF THE YIELD OF ONE OR MORE DESIRED COMPOUNDS PRODUCED BY A PLANT

(71) Applicant: Ethanol Technologies Limited, Mapou (MU)

(72) Inventors: Garth Anton Cambray, Grahamstown (ZA); Craig Dean Myers, Broadacres (ZA)

(21) Appl. No.: 17/057,016

(22) PCT Filed: May 23, 2019
(86) PCT No.: PCT/IB2019/054277

§ 371 Date: Nov. 19, 2020

(30) Foreign Application Priority Data
May 23, 2018 (ZA) 2018/03407
Dec. 14, 2018 (ZA) 2018/08445

(51) Int. Cl. A01N 37/06; A01N 37/02; A01N 27/00; A01N 31/02; A01N 57/12

(52) U.S. Cl. CPC A01N 37/06; A01N 37/02; A01N 57/12; A01N 31/02; A01N 27/00

(57) ABSTRACT

A stimulant composition to stimulate production of one or more cannabinoids by a plant producing such cannabinoids includes an optional diluent, and a lipid portion or lipid composition which includes free or saponified fatty acids, free fatty alcohols, wax esters, hydrocarbons, and at least one of a phospholipid and a terpene. The free fatty alcohols make up at least 5% by mass of the lipid portion or lipid composition. The phospholipid, when present, makes up at least 0.4% of the lipid portion or lipid composition. The terpene, when present, makes up at least 0.2% by mass of the lipid portion or lipid composition. The disclosure extends to a method of stimulating production of at least one cannabinoid in a plant producing the cannabinoid to promote increased yield of the cannabinoid.

### BACKGROUND

### Technical Field

This disclosure relates to the stimulation of the yield of one or more desired compounds produced by a plant. In particular, the disclosure relates to a stimulant composition to stimulate production of one or more cannabinoids by a plant producing such cannabinoids, to the use of the stimulant composition to stimulate production of at least one desired compound, and to a method of stimulating production of at least one cannabinoid in a plant producing said cannabinoid to promote increased yield of said at least one cannabinoid.

### Description of the Related Art

Cannabis sativa and Cannabis indica are two closely related plants which may or may not be separate species (Pollio A., 2016, The name of Cannabis: A short guide for Nonbotanists, Cannabis and Cannabinoids, Vol. 1.1, 2016). The plants contain, in their various forms, as hybrids and pure forms and various strains, a range of cannabinoid alkaloids, terpenes, and phenolic compounds (Flores-Sanchez I. J., Verpoorte R. (2008), Secondary metabolism in Cannabis. Phytochem. Raw. 7 615-639. 10.1007/s11101-008-9094-4). These compounds have proven, and in some cases still to be quantified, biological activities, which can have a medicinal nature in humans and other species.

Phytocannabinoids are a group of C21-C22 terpenophenolic compounds found in Cannabis sp. plants which have phytomedicinal effects (Christelle M. Andre, Jean-Francois Hausman, Gea Guerriero, 2016, Cannabis sativa: The Plant of the Thousand and One Molecules, Front Plant Sci. 2016; 7: 19).

Unless otherwise clear from the context in which used, the terms “terpene” and “terpenes” are used hereinafter to include terpenoid and terpenoids respectively, and unless the context indicates otherwise, also terpene and terpenoid precursors, and the terms “cannabinoid” and “cannabinoids” include phytocannabinoid and phytocannabinoids respectively.

Cannabis has been legalized, or semi legalized, in a number of countries for either medicinal, recreational, or both uses. Major economic centers such as Canada, California and a number of other US states have now developed industries which produce cannabis-derived products for sale.

Cannabis plants are cultivated commercially on a 6 to 8-week indoor growing cycle using controlled environment systems to produce cannabis buds with a high concentration of cannabinoids, terpenes, and phenolic compounds. Outdoor growing cycles are longer and growing cycles may be strain dependent.

Different strains of cannabis produce different ratios of signature compounds—some having a more medicinal effect as anti-inflammatory medications, anti-cancer medications, anti-nausea medications, appetite stimulants, insomnia treatments, and anxiety reducers and some having a more psychoactive effect giving users feelings of calmness, confusion, euphoria, and a host of other effects which are desirable to certain consumers.

Hemp, containing a low concentration of tetrahydrocannabinol, is a member of the Cannabis sativa family and is mostly grown for industrial purposes.

The synthesis of cannabinoids is complex but starts with two pathways—the polyketide pathway and the plastidal 2-C-methyl-d-erythritol 4-phosphate (MEP) pathway the polyketide pathways synthesizes a fatty acid—olivetolic acid—which the MEP pathway then extends into geranyl diphosphate (GPP) (Christelle M. Andre et al., 2016).

Within many biological systems, the overloading of a metabolic pathway with metabolites which can enter that metabolic pathway, can stimulate an organism to produce more of a specific secondary metabolite.

It would be desirable if the production of cannabinoids and other compounds of interest could be stimulated to provide enhanced yields of such cannabinoids and/or compounds from plants producing them.

### BRIEF SUMMARY

According to one aspect of the disclosure, there is provided a stimulant composition to stimulate production of one or more cannabinoids by a plant producing such cannabinoids, the stimulant composition including
an optional diluent; and
a lipid portion or lipid composition which includes free or saponified fatty acids, free fatty alcohols, wax esters, hydrocarbons and at least one of a phospholipid and a terpene, the free fatty alcohols making up at least 5% by mass of the lipid portion or lipid composition and the at least one of a phospholipid, when present, making up at least 0.4% of the lipid portion or lipid composition, and the terpene, when present, making up at least 0.2% by mass of the lipid portion or lipid composition.

The lipid portion or lipid composition may thus include one or more terpenes or terpenoids or terpene or terpenoid precursors. Instead, or in addition, the lipid portion or lipid composition may thus include one or more phospholipids.

Advantageously, the stimulant composition can be employed to stimulate bioactive cannabinoids, terpenes, and phenols production in plants of the Cannabis family, such as Cannabis sativa and Cannabis indica and in hybrids of these plants.

The one or more terpenes may be selected from the group consisting of myrcene, limonene, linalool, caryophyllene, alpha pinene, beta pinene, cineole, alpha bisabolol, trans nerolidol, humulene, camphene, borneol, terpineol, beta geraniol, geraniol, terpineol, and valencene. The one or more terpenes or terpenoids or terpene or terpenoid precursors may instead be one or more plant terpenes similar to any of the aforementioned terpene or terpenoid compounds or precursors.

The one or more terpenes may be present in the lipid portion or lipid composition in a concentration of at least about 0.5% by mass or at least about 1% by mass or at least about 1.5% by mass, e.g., about 2% by mass.

Typically, the one or more terpenes are present in the lipid portion or lipid composition in a concentration of less than about 4% by mass or less than about 3% by mass or less than about 2.5% by mass.

The free fatty alcohols may be present in the lipid portion or lipid composition in a concentration of at least about 8% by mass or at least about 10% by mass or at least about 12% by mass, e.g., about 15.6% by mass.

Typically, the free fatty alcohols are present in the lipid portion or lipid composition in a concentration of less than about 25% by mass or less than about 22% by mass or less than about 20% by mass.

The free fatty alcohols may include fatty alcohols with a carbon number ranging between 24 and 32. In other words, the free fatty alcohols may include C24-C32 fatty alcohols, i.e., saturated long chain alcohols. Typically, the free fatty alcohols are even carbon numbered.

Typically, there are no free fatty alcohols of any significant concentration with a carbon number less than 24 or with a carbon number greater than 32.

The free fatty alcohols may include one or more alcohols selected from the group consisting of 1-octacosanol, 1-triacontanol, 1-tetracosanol, 1-dotriacontanol and 1-hexacosanol.

In one embodiment of the disclosure, the free fatty alcohols include all of 1-octacosanol, 1-triacontanol, 1-tetracosanol, 1-dotriacontanol, and 1-hexacosanol. These fatty alcohols may be present in a descending concentration in the order listed hereinbefore, with 1-octacosanol thus being present in the highest concentration and 1-hexacosanol being present in the lowest concentration.

The at least one phospholipid, i.e., the one or more phospholipids, may be present in the lipid portion or lipid composition in a concentration of at least about 0.5% by mass or at least about 0.6% by mass or at least about 0.7% by mass, e.g., about 0.86% by mass.

Typically, the one or more phospholipids is/are present in the lipid portion or lipid composition in a concentration of less than about 1.2% by mass or less than about 1.1% by mass or less than about 1.0% by mass.

The phospholipid(s) may be in the form of a commercially available phospholipid, e.g., lecithin, added to a base lipid composition comprising the fatty acids, free fatty alcohols, hydrocarbons, wax esters, and one or more terpenes (or terpene precursors). The lecithin may be lecithin obtained from soybeans, rapeseed, sunflower, chicken eggs, bovine milk or fish eggs, preferably from soybeans.

Advantageously, in addition to its nutrient value, the one or more phospholipids act as an emulsifier in the stimulant composition and under certain conditions may aid the transport of components of the stimulant composition directly into plants through roots or leaves of the plants.

The fatty acids may be present in the lipid portion or lipid composition in a concentration of at least about 30% or at least about 35% or at least about 40% by mass, e.g., about 44% by mass.

Typically, the fatty acids are present in the lipid portion or lipid composition in a concentration of less than about 60% by mass or less than about 55% by mass or less than about 50% by mass.

The fatty acids may include fatty acids with a carbon number ranging between about 14 and about 28. In other words, the fatty acids may include C14-C28 fatty acids.

Typically, there are no fatty acids of any significant concentration with a carbon number less than 14 or with a carbon number greater than 28.

The fatty acids may include palmitic acid and lignoceric acid. The palmitic acid and the lignoceric acid in combination may make up more than about 50% by mass or more than about 60% by mass or more than about 70% by mass, e.g., about 75% by mass to about 85% by mass of the fatty acids present in the lipid portion or lipid composition.

The fatty acids may include additionally one or more fatty acids selected from the group consisting of tetradecanoic acid, pentadecanoic acid, stearic acid, oleic acid, vaccenic acid, linoleic acid, alpha-linolenic acid, arachidic acid, dihomo-gamma-linolenic acid, eicosatrienoic acid, eicosatetraenoic acid, eicosapentaenoic acid, behenic acid, erucic acid, cerotic acid and montanic acid.

The oleic acid may be present in the lipid portion or lipid composition in a concentration of between about 2% by mass and about 12% by mass, or between about 4% by mass and about 10% by mass, or between about 5% by mass and about 9% by mass, e.g., about 6.9% by mass.

Each of the tetradecanoic acid, pentadecanoic acid, stearic acid, vaccenic acid, linoleic acid, alpha-linolenic acid, arachidic acid, dihomo-gamma-linolenic acid, eicosatrienoic acid, eicosatetraenoic acid, eicosapentaenoic acid, behenic acid, erucic acid, cerotic acid and montanic acid, when present in the lipid portion or lipid composition, may be present in a concentration of less than about 4% by mass or less than about 3.5% by mass or less than about 3% by mass. Typically, each of these fatty acids, when present in the lipid portion or lipid composition, are present in a concentration of at least about 0.01% by mass or at least about 0.02% by mass or at least about 0.03% by mass.

The hydrocarbons may be present in the lipid portion or lipid composition in a concentration of at least about 8% by mass or at least about 10% by mass or at least about 12% by mass, e.g., about 14% by mass.

Typically, the hydrocarbons are present in the lipid portion or lipid composition in a concentration of less than about 20% by mass or less than about 18% by mass or less than about 16% by mass.

The hydrocarbons may include hydrocarbons with a carbon number ranging between about 25 and about 35. In other words, the hydrocarbons may include C25-C35 hydrocarbons.

Typically, there are no hydrocarbons of any significant concentration with a carbon number less than 25 or with a carbon number greater than 35.

The hydrocarbons may include one or more alkanes selected from the group consisting of 25:0, 27:0, 29:0, 31:0, 33:0, and 35:0.

The hydrocarbons may include one or more alkenes selected from the group consisting of 33:1 and 35:1.

The wax esters, i.e., esters of a fatty acid and a fatty alcohol, may be present in the lipid portion or lipid composition in a concentration of at least about 18% by mass or at least about 20% by mass or at least about 22% by mass, e.g., about 26% by mass.

Typically, the wax esters are present in the lipid portion or lipid composition in a concentration of less than about 34% by mass or less than about 32% by mass or less than about 30% by mass.

The wax esters may include wax esters with a carbon number ranging between about 34 and about 56. In other words, the wax esters may include C34-C56 wax esters, or C36-C54 wax esters. Typically, these wax esters are even carbon numbered, with principle alkyl esters being C40, C42, C44, C46, and C48. The wax esters may predominantly be monoesters, with smaller amounts of diesters and triesters and polyesters also being present. The wax esters may also include mono, di and triglycerides.

Typically, there are no wax esters of any significant concentration with a carbon number less than 34 or with a carbon number greater than 56.

The lipid portion or lipid composition may include sterols and/or amino acids and/or glycerol. All of these, if present, may be present in a concentration of less than about 8% by mass each. The sterols may be attached to the fatty acids or to the fatty alcohols.

The sterols may include one or more of cholesterol, campesterol, campestanol, d5,24 stigmastadienol, d7 stigmasterol, and d7 avenasterol.

The amino acids, when present, may include phenylalanine.

In the absence of a diluent, the lipid portion or lipid composition, and hence the stimulant composition, may be in the form of a hydrophobic powder.

The diluent may be water. When the diluent is water, the stimulant composition may be in the form of an oil-in-water emulsion.

In one embodiment of the disclosure, the stimulant composition is in the form of an aqueous cream. In another embodiment of the disclosure, the stimulant composition is in the form of a liquid, waxy liquid, or wax.

The diluent, when water, may be present in a concentration of between about 80% and about 99% by mass, or between about 85% and about 99% by mass, or between about 90% and about 96% by mass, e.g., about 94% by mass, of the stimulant composition.

The stimulant composition may include an antioxidant.

In one embodiment of the disclosure, the antioxidant includes potassium metabisulfite and/or ascorbic acid (vitamin C) and/or ascorbyl palmitate. Potassium metabisulfite advantageously scavenges oxygen, whereas ascorbic acid advantageously protects fats on the aqueous side of micelles with ascorbyl palmitate protecting micelles on the lipid side thereof. Typically, the minimum amount of antioxidant necessary to prevent the stimulant composition from going rancid is used. Thus, for example, the potassium metabisulfite concentration in the stimulant composition may be between about 20 parts per million by mass and about 80 parts per million by mass, the ascorbic acid concentration in the stimulant composition may be between about 0.04% by mass and about 0.1% by mass and the ascorbyl palmitate concentration in the stimulant composition may be between about 0.04% by mass and about 0.1% by mass.

The stimulant composition may include vitamin E to inhibit rancidity. The vitamin E, when present, may be present in a concentration of between about 0.003% by mass and about 0.009% by mass.

The disclosure extends to the use of the stimulant composition as hereinbefore described to stimulate production of at least one cannabinoid in a plant producing said cannabinoid to promote increased yield of said at least one cannabinoid.

The disclosure also extends to the use of the stimulant composition as hereinbefore described to stimulate production of at least one terpene and/or at least one phenolic compound in a plant producing said terpene and/or said phenolic compound to promote increased yield of said at least one terpene and/or phenolic compound.

The disclosure further extends to the use of the stimulant composition as hereinbefore described to stimulate production of at least one bioactive compound other than a cannabinoid, terpene, and phenolic compound, in a plant producing said bioactive compound to promote increased yield of said bioactive compound.

The disclosure yet further extends to the use of a stimulant composition comprising free or saponified fatty acids, free fatty alcohols, wax esters, and hydrocarbons, optionally at least one phospholipid, and optionally at least one terpene, to stimulate production of at least one of a cannabinoid, a terpene, or a phenolic compound, in a plant producing a cannabinoid or a terpene or a phenolic compound.

The disclosure also extends to the use of a stimulant composition comprising free or saponified fatty acids, free fatty alcohols, wax esters, and hydrocarbons, optionally at least one phospholipid, and optionally at least one terpene, to increase prevalence of root hairs and/or mycorrhizal growth in plants, and/or to increase the concentration of roots in an upper soil level, and/or to stimulate root growth, and/or to increase plant stem thickness and/or plant stem strength, and/or to increase branch tip cola development, and/or to stimulate development of thicker cuticles on leaves, and/or to increase leaf trichome size, and/or to increase alkaloid levels in buds, and/or to increase extractable oils, and/or to increase bud mass or bud density or thickness, and/or to provide earlier bud development, and/or to influence the flavor profile of buds, and/or to deliver terpenes into buds, and/or to cause plants to mature earlier, and/or to bleach chlorophyll from buds, and/or to increase pest resistance, in plants treated with the stimulant composition.

The stimulant composition may be as hereinbefore described.

According to another aspect of the disclosure, there is provided a method of stimulating production of at least one cannabinoid in a plant producing said cannabinoid to promote increased yield of said at least one cannabinoid, the method including applying a stimulant composition that includes a lipid portion, or applying a lipid composition, to foliage of said plant or to soil or a growth medium in which said plant is growing, the stimulant composition, or the lipid portion of the stimulant composition, as the case may be, including free or saponified fatty acids, free fatty alcohols, wax esters, and hydrocarbons.

By “foliage” is meant leaves and buds, when present.

The free fatty alcohols may make up at least about 5% by mass of the lipid composition or at least about 5% by mass of the lipid portion of the stimulant composition.

The lipid composition or the lipid portion of the stimulant composition, as the case may be, may include one or more terpenes.

The lipid composition or the lipid portion of the stimulant composition, as the case may be, may include one or more phospholipids.

The one or more phospholipids may make up at least about 0.4% by mass of the lipid portion or lipid composition.

The one or more terpenes may make up at least about 0.2% by mass of the lipid portion or lipid composition.

The stimulant composition may include a diluent. The diluent may be as hereinbefore described.

The lipid composition may be the same as, or may correspond to, the lipid portion hereinbefore described.

The lipid portion of the stimulant composition may be as hereinbefore described.

The stimulant composition may be as hereinbefore described.

The plant may be Cannabis sp., e.g., Cannabis sativa or Cannabis indica or a hybrid of Cannabis sativa and Cannabis indica, or hemp.

Applying a stimulant composition that includes a lipid portion, or applying a lipid composition, to foliage of said plant or to soil or a growth medium in which said plant is growing may include adding the stimulant composition or the lipid composition to water or to a nutrient solution that is provided to said plant.

Preferably, the stimulant composition, or the lipid composition, is applied during the growth and flowering phases of plants to achieve the desired result of stimulating production of at least one cannabinoid in a plant producing said cannabinoid to promote increased yield of said at least one cannabinoid.

### BRIEF DESCRIPTION OF THE SEVERAL VIEWS OF THE DRAWINGS

Embodiments of the disclosure are now described with reference to the following studies and the accompanying illustrations and drawings.

In the illustrations and drawings,

FIG. 1 is a Scanning Electron Micrograph (SEM) image of root hair fibers of a White Widow control plant and a White Widow plant treated with a stimulant composition of the disclosure, without added terpenes;

FIG. 2 is an SEM image of root hair fibers of a Kings Kush control plant and a Kings Kush plant treated with a stimulant composition of the disclosure, without added terpenes;

FIG. 3 is a graph illustrating increased root length of Holy Grail Kush plants treated with a stimulant composition of the disclosure, without added terpenes, in an incubator, compared to Holy Grail Kush control plants in the incubator;

FIG. 4 is a graph illustrating increased root length of hemp plants treated with a stimulant composition of the disclosure, without added terpenes, in a greenhouse, compared to hemp control plants in the greenhouse;

FIG. 5 is a graph illustrating increased root length of Holy Grail Kush plants treated with a stimulant composition of the disclosure, with added terpenes, in a greenhouse, compared to Holy Grail Kush control plants in the greenhouse;

FIG. 6 is a graph illustrating increased root length of Holy Grail Kush plants treated with a stimulant composition of the disclosure, with added terpenes from a Hehchrysum species, in a greenhouse, compared to Holy Grail Kush control plants in the greenhouse;

FIG. 7 shows a photograph of the roots of three Holy Grail Kush plants treated in an incubator according to different regimes with a stimulant composition of the disclosure, without added terpenes, and the roots of a control plant;

FIG. 8 shows a photograph of the roots of three hemp plants treated in a greenhouse according to different regimes (hemp trial A) with a stimulant composition of the disclosure, without added terpenes, and the roots of a control plant;

FIG. 9 shows a photograph of the roots of three hemp plants treated in a greenhouse according to different regimes (hemp trial B) with a stimulant composition of the disclosure, without added terpenes, and the roots of a control plant;

FIG. 10 shows a photograph of the roots of three Holy Grail Kush plants treated in a greenhouse according to different regimes with a stimulant composition of the disclosure, with added terpenes, and the roots of a control plant;

FIG. 11 shows a photograph of the roots of three Holy Grail Kush plants treated in a greenhouse according to different regimes with a stimulant composition of the disclosure, with added terpenes from a Hehchrysum species, and the roots of a control plant;

FIG. 12 is an SEM image of leaf trichomes of a Kings Kush control plant and a Kings Kush plant treated with a stimulant composition of the disclosure, without added terpenes;

FIG. 13 is an SEM image of leaf trichomes of a Super Lemon Haze T control plant and a Super Lemon Haze T plant treated with a stimulant composition of the disclosure, without added terpenes;

FIG. 14 is an SEM image of leaf trichomes of a The Church control plant and a The Church plant treated with a stimulant composition of the disclosure, without added terpenes;

FIG. 15 is an SEM image of leaf trichomes of a White Rhino control plant and a White Rhino plant treated with a stimulant composition of the disclosure, without added terpenes;

FIG. 16 is an SEM image of leaf trichomes of a White Widow control plant and a White Widow plant treated with a stimulant composition of the disclosure, without added terpenes;

FIG. 17 is an SEM image of leaf trichomes of a hemp control plant from a field and from a hemp plant from a field treated with a stimulant composition of the disclosure, without added terpenes;

FIG. 18 is an SEM image of leaf trichomes of a hemp control plant and a hemp plant treated with a stimulant composition of the disclosure, without added terpenes;

FIG. 19 is an SEM image of under leaf trichomes of a hemp control plant and a hemp plant treated with a stimulant composition of the disclosure, without added terpenes;

FIGS. 20-22 are SEM images of hemp leaf transects for a hemp control plant and a hemp plant treated with a stimulant composition of the disclosure, without added terpenes;

FIG. 23 is an SEM images of a leaf transect for a Super Lemon Haze C control plant and a Super Lemon Haze C plant treated with a stimulant composition of the disclosure, without added terpenes;

FIG. 24 is an SEM images of a leaf transect for a The Church control plant and a The Church plant treated with a stimulant composition of the disclosure, without added terpenes;

FIG. 25 is an SEM images of a leaf transect for a White Rhino control plant and a White Rhino plant treated with a stimulant composition of the disclosure, without added terpenes;

FIG. 26 is an SEM images of a leaf transect for a White Widow control plant and a White Widow plant treated with a stimulant composition of the disclosure, without added terpenes;

FIG. 27 is a graph illustrating increased bud count and bud wet weight of Holy Grail Kush plants treated with a stimulant composition of the disclosure, without added terpenes, in an incubator, compared to Holy Grail Kush control plants in the incubator;

FIG. 28 is a graph illustrating increased bud count and bud wet weight of hemp plants treated with a stimulant composition of the disclosure, without added terpenes, in a greenhouse, compared to hemp control plants in the greenhouse—the bud wet weight of the control is too low to show in the graph;

FIG. 29 is a graph illustrating increased bud count and bud wet weight of Holy Grail Kush plants treated with a stimulant composition of the disclosure, in some dosages without added terpenes and in some dosages with added terpenes from a Hehchrysum species, in a greenhouse, compared to Holy Grail Kush control plants in the greenhouse—the bud wet weight of the control is too low to show in the graph;

FIG. 30 is a graph illustrating oil extraction for Holy Grail Kush plants treated with a stimulant composition of the disclosure in a greenhouse, without added terpenes compared to Holy Grail Kush control plants from the greenhouse;

FIG. 31 shows a photograph of the stems of cannabis plants being subjected to a postharvest soak in a stimulant composition of the disclosure;

FIG. 32 is a further SEM image of leaf trichomes of a Kings Kush control plant and a Kings Kush plant treated with a stimulant composition of the disclosure, without added terpenes;

FIG. 33 is a further SEM image of leaf trichomes of a Super Lemon Haze T control plant and a Super Lemon Haze T plant treated with a stimulant composition of the disclosure, without added terpenes;

FIG. 34 is a further SEM image of leaf trichomes of a The Church control plant and a The Church plant treated with a stimulant composition of the disclosure, without added terpenes;

FIG. 35 is a further SEM image of leaf trichomes of a White Rhino control plant and a White Rhino plant treated with a stimulant composition of the disclosure, without added terpenes;

FIG. 36 is a further SEM image of leaf trichomes of a White Widow control plant and a White Widow plant treated with a stimulant composition of the disclosure, without added terpenes;

FIG. 37 is a further SEM image of leaf trichomes of a hemp control plant and a hemp plant treated with a stimulant composition of the disclosure, without added terpenes;

FIG. 38 is a further SEM image of leaf trichomes of a Holy Grail Kush control plant and a Holy Grail Kush plants treated with different dosages of a stimulant composition of the disclosure, without added terpenes;

FIG. 39 is a further SEM image of leaf trichomes of a Sex Wax control plant and Sex Wax plants treated with different dosages of a stimulant composition of the disclosure, without added terpenes; and

FIG. 40 is a further SEM image of leaf trichomes of Banana Dre Kush plants treated with different dosages of a stimulant composition of the disclosure, without added terpenes.

### DETAILED DESCRIPTION

### Study 1

An exemplary stimulant composition in accordance with the disclosure was prepared. The stimulant composition included a base lipid portion and water as a diluent, forming a water-in-oil emulsion, in the form of a liquid. The base lipid portion made up about 6.86% by mass of the stimulant composition, with the balance being predominantly water and small amounts of other ingredients or additives, including added phospholipids, an added terpene, added potassium metabisulfite, added ascorbic acid, added ascorbyl palmitate, sterols, and added vitamin E.

Table 1 provides the concentrations of all significant ingredients of the base lipid portion, including phospholipids, and hence of the stimulant composition, but for the exemplified stimulant composition Table 1 does not show the amount of water or any other added ingredients, such as added antioxidants. Table 1 also does not show any terpene content of the stimulant composition and Table 1 is thus provided on a terpene-free basis.

TABLE 1

| | | Concentration in | Concentration (% |
|---|---|---|---|
| | | stimulant composition | by mass) in the |
| | | mg/100 g on a terpene- | lipid portion on a |
| Ingredient name | Fatty Acid | free basis | terpene-free basis |
| myristic acid/Tetradecanoic acid | 14:0 | 10.35 | 0.15 |
| pentadecylic acid/pentadecanoic acid | 15:0 | 15.02 | 0.22 |
| Palmitic acid | 16:0 | 1551.25 | 22.62 |
| | 16:1 | 8.48 | 0.12 |
| Stearic acid | 18:0 | 60.04 | 0.88 |
| Oleic acid | 18:1(n-9) | 208.44 | 3.04 |
| Vaccenic acid | 18:1(n-7) | 38.32 | 0.56 |
| Linoleic acid (LA) | 18:2(n-6) | 77.03 | 1.12 |
| Alpha-linolenic acid (ALA) | 18:3(n-3) | 7.05 | 0.10 |
| | 18:4 | 1.34 | 0.02 |
| Arachidic acid | 20:0 | 7.63 | 0.11 |
| | 20:1 | 14.97 | 0.22 |
| Eicosadienoic acid | 20:2(n-6) | 0.00 | 0.00 |
| Dihomo-gamma-linolenic acid(DGLA) | 20:3(n-6) | 3.34 | 0.05 |
| Arachidonic acid (AA, ARA) | 20:4(n-6) | 0.00 | 0.00 |
| Eicosatrienoic acid (ETE) | 20:3(n-3) | 3.90 | 0.06 |
| Eicosatetraenoic acid (ETA) | 20:4(n-3) | 3.90 | 0.06 |
| Eicosapentaenoic acid (EPA) | 20:5(n-3) | 7.23 | 0.11 |
| Behenic acid | 22:0 | 25.74 | 0.38 |
| Erucic Acid | 22:1 | 3.45 | 0.05 |
| Lignoceric acid | 24:0* | 861.91 | 12.57 |
| Cerotic acid | 26:0* | 69.82 | 1.02 |
| Montanic acid | 28:0* | 50.56 | 0.74 |

Fatty Alcohol

| | | | |
|---|---|---|---|
| Lignoceryl alcohol (1-tetracosanol) | 24:0-OH | 234.86 | 3.43 |
| Ceryl alcohol (1-hexacosanol) | 26:0-OH | 125.58 | 1.83 |
| Montanyl alcohol, cluytyl alcohol, or 1-octacosanol | 28:0-OH | 270.18 | 3.94 |
| Myricyl alcohol, melissyl alcohol, or 1-triacontanol | 30:0-OH | 262.53 | 3.83 |
| 1-Dotriacontanol (Lacceryl alcohol) | 32:0-OH | 175.50 | 2.56 |

Wax esters

| | | |
|---|---|---|
| C34 - C56 wax esters and small amounts of micro components | 1799.54 | 26.24 |

Hydro-carbons

| | | |
|---|---|---|
| Hydrocarbon 25:0 | 63.36 | 0.92 |
| Hydrocarbon 27:0 | 319.67 | 4.66 |
| Hydrocarbon 29:0 | 132.48 | 1.93 |
| Hydrocarbon 31:0 | 85.44 | 1.25 |
| Hydrocarbon 33:0 | 147.84 | 2.16 |
| Hydrocarbon 35:0 | 31.68 | 0.46 |
| Hydrocarbon 33:1 | 62.40 | 0.91 |
| Hydrocarbon 35:1 | 117.12 | 1.71 |
| Total | 6857.93 | 100 |

The stimulant composition of Table 1 was adjusted with the addition of antioxidants and with the addition of a phospholipid in the form of lecithin, with the lecithin making up about 0.5% by mass of the final or exemplified stimulant composition. The stimulant composition was also adjusted with the addition of a terpene, namely geraniol (a monoterpenoid and an alcohol), which is a commercially available product. The final or exemplified stimulant composition included about 2% by mass terpene. The exemplified stimulant composition was demonstrated to be stable for at least three months if stored in an airtight container. When added to water at a temperature above 35° C., the exemplified stimulant composition dispersed rapidly and mixed into the water leaving no visible residues. From the analysis in Table 1 it can be seen that the exemplified stimulant composition includes a significant concentration of wax esters of fatty alcohols and fatty acids corresponding to the fatty alcohols and fatty acids listed. A smaller percentage of free fatty acids, typically in the form of potassium salts or soaps, and free fatty alcohols, as well as added phospholipids and terpene, are present and emulsify the stimulant composition to produce a unique suspension of wax esters, fatty acids, fatty alcohols, alkanes, some alkenes, lipids in general, and a terpene which are in a fine micellular suspension that is easily applied to soil or to a growth medium or to foliage of plants.

The exemplified stimulant composition was applied to a high yielding cannabis strain (a Cannabis indica/sativa hybrid known as Holy Grail Kush, bred by DNA Genetics and Riserva Privada Colorado), grown under controlled conditions. A control block of the same cannabis strain was grown under the same controlled conditions, without application of the stimulant composition.

Table 2 shows the results of a quantitative liquid chromatography with mass spectroscopy detection analysis of the cannabis strain grown under controlled conditions without the stimulant composition (A1-A3) and with the stimulant composition (G1-G3). Since plant extracts were prepared at 100 μg/mL, concentration for cannabinoids can directly be converted to weight percentage in plant material. The significant overall yield improvement in tetrahydrocannabinol (THC), cannabigerol (CBG), tetrahydrocannabinolic acid (THCA), cannabidiolic acid (CBDA) and cannabigerolic acid (CBGA) is apparent. Cannabidivarin (CBDV), cannabinol (CBN) and cannabidiol (CBD) were not detected for the tested cannabis strain due to the method used.

TABLE 2

| Sample | CBDV | CBN | THC | CBD | CBG | THCA | CBDA | CBGA |
|---|---|---|---|---|---|---|---|---|
| A1 | N/D | N/D | 147091.5 | N/D | 3005.217 | 1906079 | 1636.607 | 12489.3 |
| c (μg/mL) | N/D | N/D | 0.802344 | N/D | 0.005948 | 10.48477 | 0.04127 | 0.094683 |
| wt % | N/D | N/D | 0.80% | N/D | 0.01% | 10.48% | 0.04% | 0.09% |
| A2 | N/D | N/D | 142704.3 | N/D | 9565.078 | 2154013 | 2264.359 | 15682.65 |
| c (μg/mL) | N/D | N/D | 0.778194 | N/D | 0.067323 | 11.84954 | 0.044604 | 0.12456 |
| wt % | N/D | N/D | 0.78% | N/D | 0.07% | 11.85% | 0.04% | 0.12% |
| A3 | N/D | N/D | 162472 | N/D | 4514.337 | 2475178 | 3859.571 | 15735.81 |
| c (μg/mL) | N/D | N/D | 0.887007 | N/D | 0.020068 | 13.6174 | 0.053077 | 0.125058 |
| wt % | N/D | N/D | 0.89% | N/D | 0.02% | 13.62% | 0.05% | 0.13% |
| Average A | N/D | N/D | 0.82% | N/D | 0.03% | 11.98% | 0.05% | 0.11% |
| G1 | N/D | N/D | 201519.8 | N/D | 5897.237 | 2527231 | 4999.383 | 23757.68 |
| c (μg/mL) | N/D | N/D | 1.101947 | N/D | 0.033006 | 13.90393 | 0.059131 | 0.200112 |
| wt % | N/D | N/D | 1.10% | N/D | 0.03% | 13.90% | 0.06% | 0.20% |
| G2 | N/D | N/D | 192697.7 | N/D | 14222.13 | 2488212 | 4574.897 | 16297.56 |
| c (μg/mL) | N/D | N/D | 1.054871 | N/D | 0.110896 | 13.68915 | 0.056876 | 0.130314 |
| wt % | N/D | N/D | 1.05% | N/D | 0.11% | 13.69% | 0.06% | 0.13% |
| G3 | N/D | N/D | 205482.6 | N/D | 26621.88 | 2735551 | 3898.017 | 19464.39 |
| c (μg/mL) | N/D | N/D | 1.12376 | N/D | 0.22691 | 15.05064 | 0.053281 | 0.159943 |
| wt % | N/D | N/D | 1.12% | N/D | 0.23% | 15.05% | 0.05% | 0.16% |
| Average G | N/D | N/D | 1.09% | N/D | 0.12% | 14.21% | 0.06% | 0.16% |

### Study 2

The stimulant composition of Study 1, with and without added terpenes, was applied to varies cannabis strains (hereinafter “treated plants”). Control plants were not provided with the stimulant composition. Stem thickness was measured for the treated plants and for the control plants at soil level and at a height of 150 mm above soil level. The treated plants and the control plants were of equal age. Table 3 shows that the treated plants demonstrated more pronounced stem thickening, with stem thickness being up to 60% more in certain cannabis strains, with an average increase in thickness of 30% across cannabis strains tested. Stem thickness and strength corresponds to greater ability of plants to support weigh, and final bud volumes that can be achieved are hence greater as the risk of catastrophic branch failure is reduced. The stimulant composition, as exemplified, also stimulates lateral branch development in earlier growth, increasing branch tip counts for cola development, and hence overall yield in plants.

In Table 3, HGK refers to the Holy Grail Kush strain, CAN+ refers to the stimulant composition of Study 1 without any added terpenes, CAN+T refers to the stimulant composition of Study 1 with added terpenes in a range of less than 1% by mass to about 3% by mass, and CAN+TMP refers to the stimulant composition of Study 1 with added terpenes from a Helichrysum species in a range of less than 1% by mass to about 3% by mass. Plants such as Hehchrysum odoratissimum and Helichrysum petiolare are considered medicinal in South Africa.

TABLE 3

| | | | Stem | Stem | % | % |
|---|---|---|---|---|---|---|
| | | | thickness at | thickness | Difference to | Difference |
| Strain or trial | | | soil level | (mm) at | control at | to control at |
| identifier | Trial | | (mm) | 150 mm height | soil level | 150 mm height |
| HGK1 | control | | 4.2 | 2.8 | | |
| HGK2 | control | | 4.42 | 2.5 | | |
| HGK3 | 3 | ml/l | 4.8 | 3.45 | 111.37 | 130.19 |
| HGK4 | 3 | ml/l | 5.25 | 3.34 | 121.81 | 126.04 |
| HGK5 | 5 | ml/l | 4.55 | 3.6 | 105.57 | 135.85 |
| HGK6 | 10 | ml/l | 4.7 | 3.8 | 109.05 | 143.40 |
| HGK7 | 10 | ml/day | 4.2 | 3.1 | 97.45 | 116.98 |
| Hemp A | Control | | 4.43 | 2.9 | | |
| Hemp A | 3 | ml/l | 4.31 | 3.4 | 109.67 | 141.67 |
| Hemp A | 5 | ml/l | 6.26 | 4.6 | 159.29 | 191.67 |
| Hemp A | 10 | ml/l | 6.3 | 5.7 | 160.31 | 237.50 |
| Hemp B | Control | | 3.43 | 1.9 | | |
| Hemp B | 3 | ml/l | 6.4 | 4.8 | 162.85 | 200.00 |
| Hemp B | 5 | ml/l | 4.6 | 3.16 | 117.05 | 131.67 |
| Hemp B | 10 | ml/l | 5.33 | 3.71 | 135.62 | 154.58 |
| HGK CAN + T | Control | | 2.7 | 1.8 | | |
| HGK CAN + T | 5 | ml/l | 4.1 | 2.8 | 151.85 | 155.56 |
| HGK CAN + T | 5 | ml/l | 3.8 | 2.6 | 140.74 | 144.44 |
| HGK CAN + T | 10 | ml/l | 3.1 | 2.8 | 114.81 | 155.56 |
| HGK CAN + TMP | Control | | 3.03 | | | |
| HGK CAN + TMP | 3 | ml/l | 3.57 | 2.11 | 117.82 | |
| HGK CAN + TMP | 5 | ml/l | 3.9 | 2.11 | 128.71 | |
| HGK CAN + TMP | 10 | ml/l | 4.82 | 2.24 | 159.08 | |

### Study 3

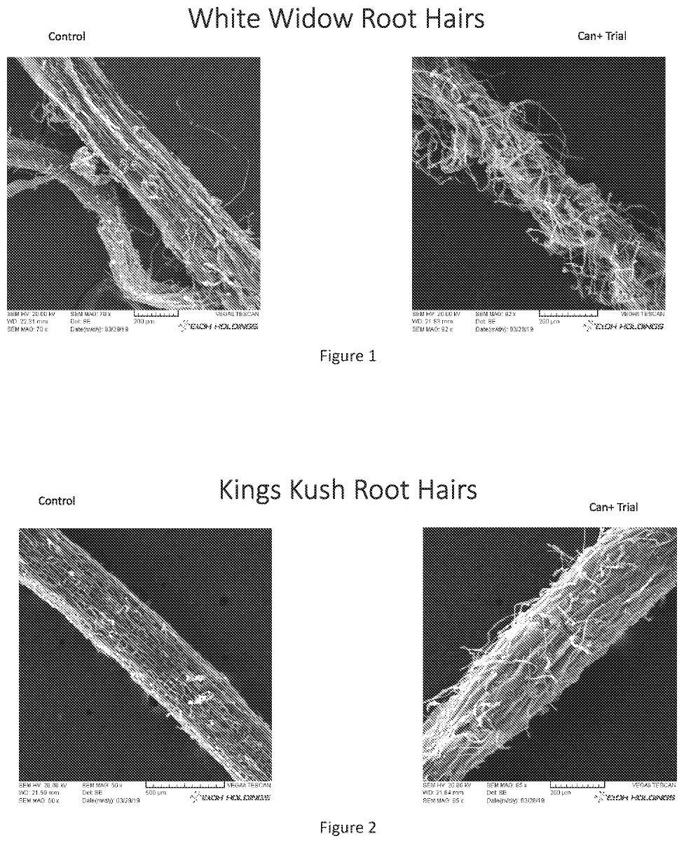

Scanning Electron Micrograph (SEM) analysis of root hair fibers of plants of equal age revealed that treatment with the stimulant composition of Study 1, without added terpenes, caused considerable increases in the prevalence of both root hairs and mycorrhizal growth (fungal symbiotic growth assisting plants to access nutrients such as phosphates which are difficult to access without the symbiotic mycorrhizae). This is illustrated in FIGS. 1 and 2.

On site analysis of the treated plants showed a far greater concentration of roots in the surface—close to 80% more roots within the top 2 centimeters of the potting soil. Roots tended to congregate in the treated areas, demonstrating that the stimulant composition induced a chemotaxic response in cannabis plants.

### Study 4

Root development was studied by comparing the roots of treated and control Holy Grail Kush plants of equal age, grown in an incubator and in a greenhouse. The stimulant composition, as exemplified, consistently stimulated root development—treated medical/recreational cannabis plants exhibited root development up to 230% greater than the control, and treated hemp plants exhibited root development up to 180% greater in length, with root volume being more than 6 time greater in treated plants than in control plants.

Postharvest autopsies of plants exhibited hugely increased root development with treated plants showing greater proliferation of root fibers into bark chips and pearlite particles in the soil mixture (growth medium).

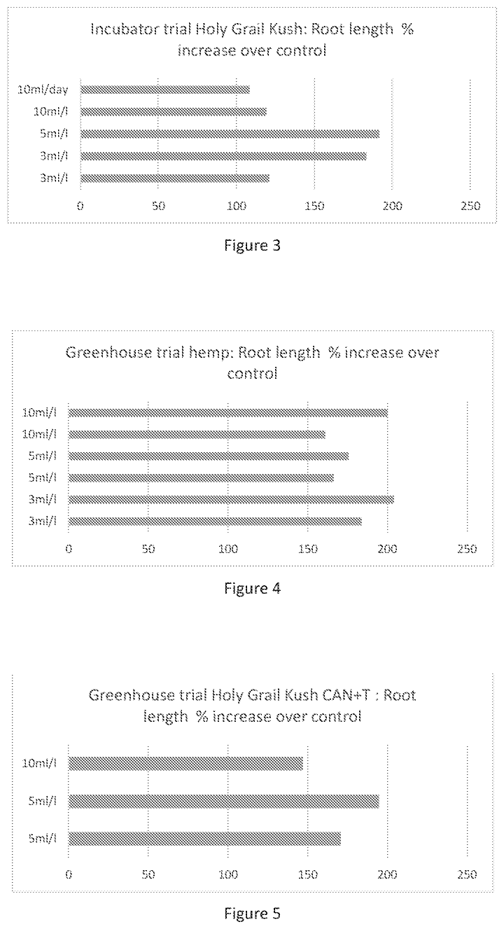

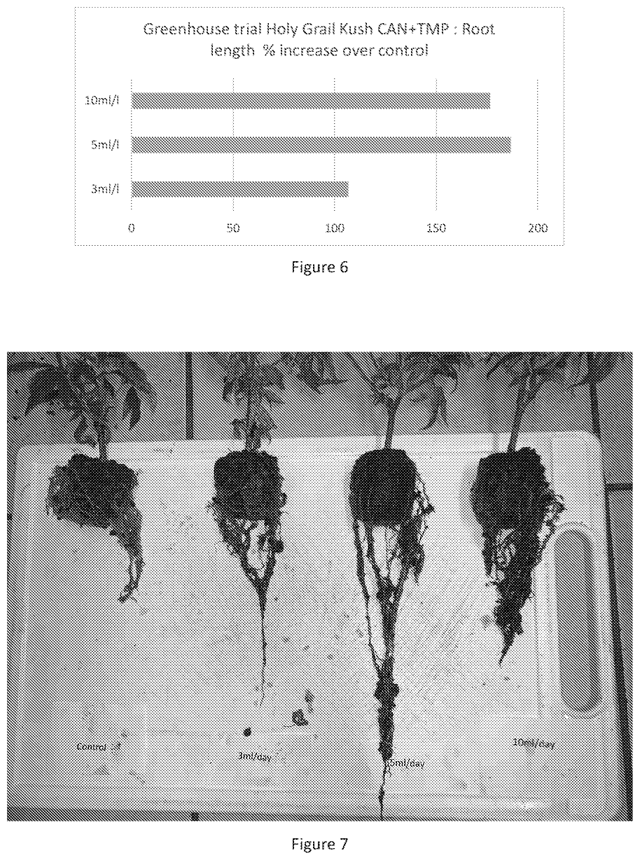

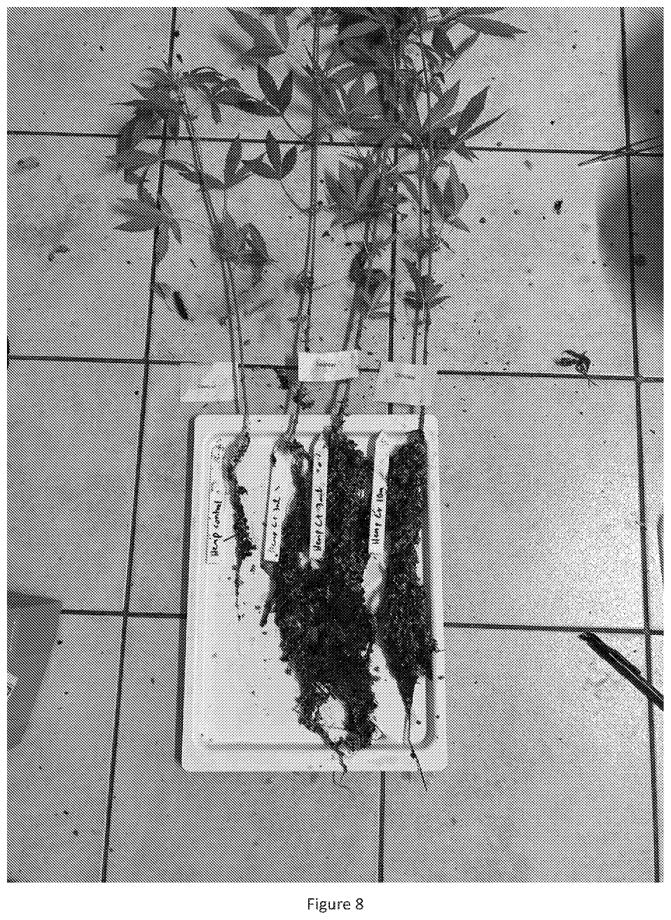

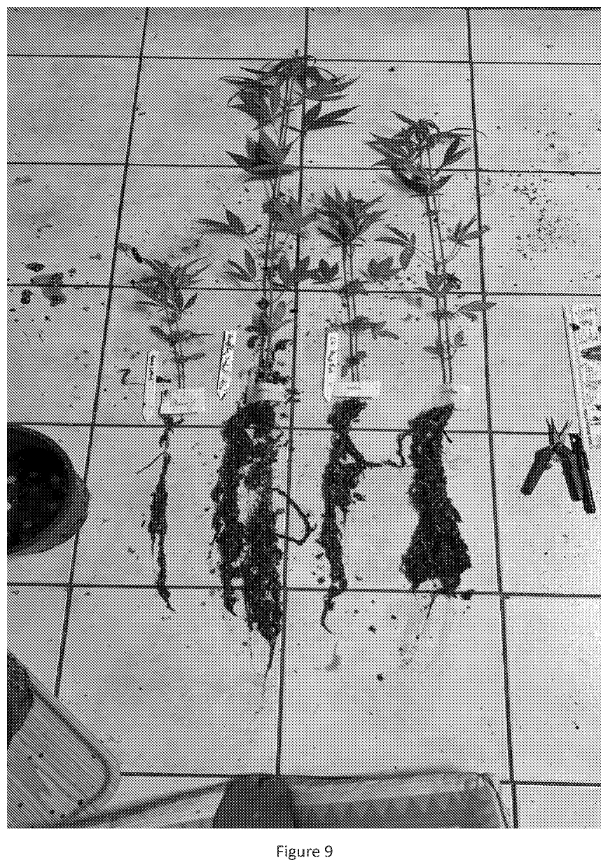

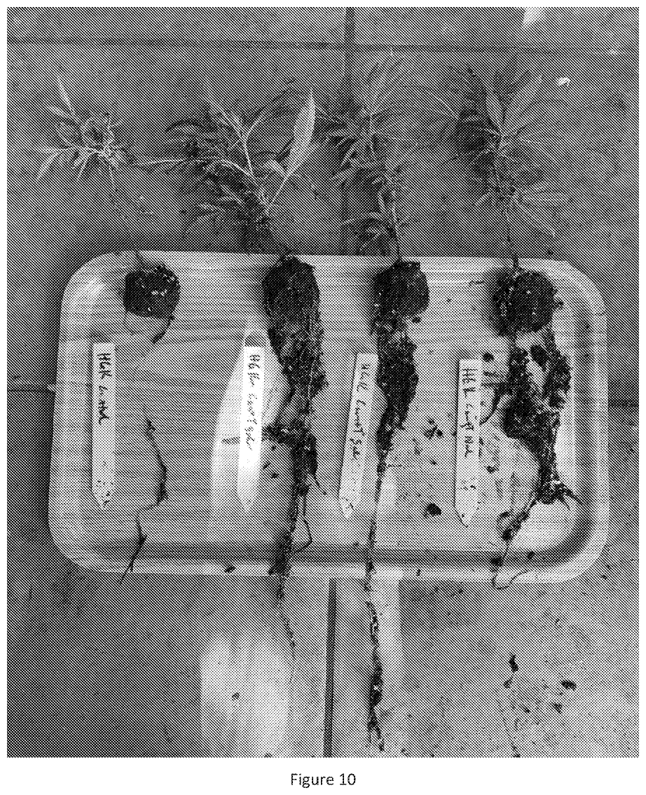

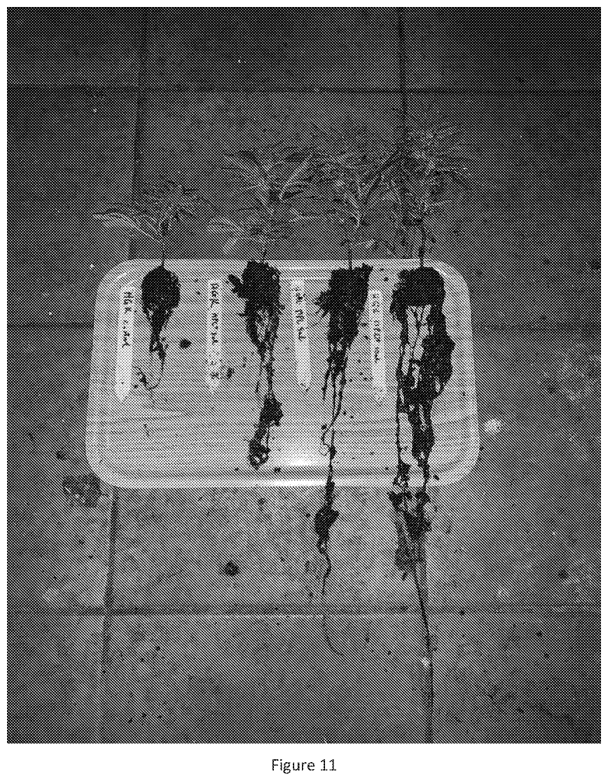

FIGS. 3-11 further illustrate some of the results of the study into root development.

### Study 5

A study was undertaken to compare the leaves of plants treated with the stimulant composition of Study 1, without added terpenes, and the leaves of control plants.

For leaf trichome analysis, samples were taken at the initiation of bud formation. At this stage in plant growth, trichomes are forming, and the metabolic pathways that result in the production of metabolites are starting to become active. The larger the trichomes are at this point, the greater the metabolic potential of the glands are to produce a high yield of product. The plants were sampled at bud initiation—however it must be noted that the treated plants were potted out 17 days later than the control plants, meaning that the trial plants were negatively prejudiced as bud initiation was delayed for them.

The study revealed that treated plants exhibited healthier leaf development with greener leaves and less leaves demonstrating nutrient limitation induced chlorosis (as a result of better nutrient uptake due to increased root health). The addition of the stimulant composition, without added terpenes, caused cannabis plants to develop thicker cuticles with more of a pronounced waxy texture. This was evident in both hemp (open seeded varieties with large genetic variation) and medical/recreational strains (close pollinated genetically non-variable) of cannabis tested. Strains tested included White Rhino, White Widow, Kings Kush, The Church, Super Lemon Haze T and Super Lemon Haze C, Holy Grail Kush, Sex Wax, Banana Dre, Citrus Diesel Kush, Agent Orange, Truth Tree, and Amherst Sour Diesel.

SEM analysis of leaf surface trichomes revealed that in early stage bud formation (two weeks after initiation of bud development) trichomes were 30-40% larger on the leaf surface in plants treated with the stimulant composition versus untreated plants.

SEM analysis of leaf surface trichomes also showed that trichomes bulged more in treated plants, suggesting a change in composition of the trichome making the substances more viscous, and hence increasing the non-Newtonian fluid properties of the resins, thus resulting in the bulging trichome base.

SEM analysis of under leaf trichomes revealed that in early stage bud formation (two weeks after initiation of bud development) trichomes were longer and thicker (up to 100% larger in certain strains, with an average of 50% larger in all strains). The treated plants were noted to be more resistant to insect and fungal damage as a consequence.

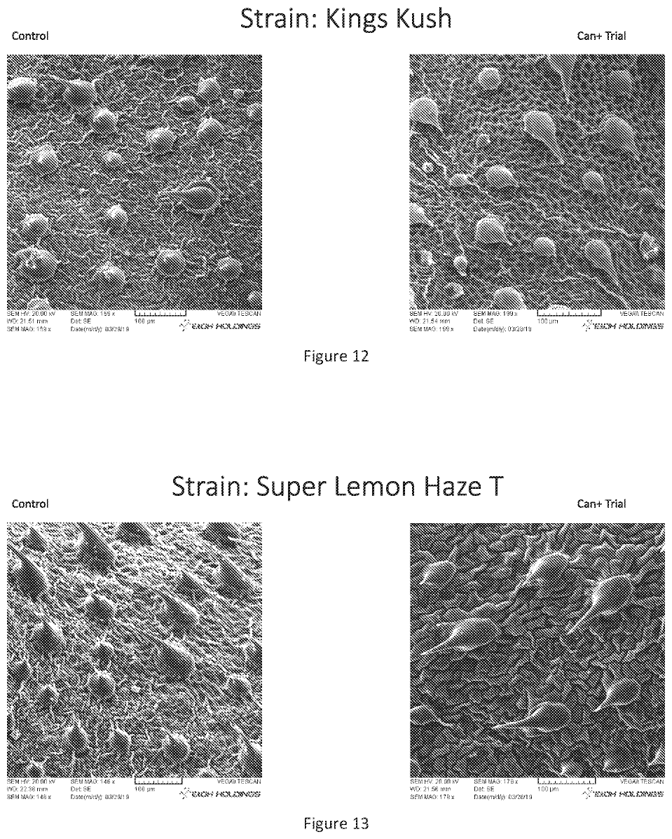

With reference to FIG. 12, for Kings Kush, the trichomes on the control are spindly and hair-like with a ring around the trichome. The trichomes on the treated plant are bulbous and larger with a significantly larger internal volume and protrude over the cuticle. From a visual analysis, there is approximately a 30% difference in the volume of trichomes between the control and the treated plants. The increased cuticular wax layer in the treated plant is noteworthy. This corresponds to greater climate variation tolerance and disease resistance. With greater variability in climate extremes becoming the norm, this is important. This shows overall that the treated plants are much healthier and absorbing nutrients better.

With reference to FIG. 13, for Super Lemon Haze T, the difference between trichomes in the control versus the treated plant is more subtle. There is however a general trend towards the trichomes being larger in the treated plant, with a much thicker hair structure. This strain produces THC later in growth, hence it will be interesting to observe the late growth stage comparison. It is also important to note that the difference in transplant time between the control and the experiment in this case is more than 17 days strongly prejudicing the results against the treated plant—yet the trichomes in the treated plant are still generally greater, meaning the stimulant composition has allowed the treated plant to catch up to the more advanced control.

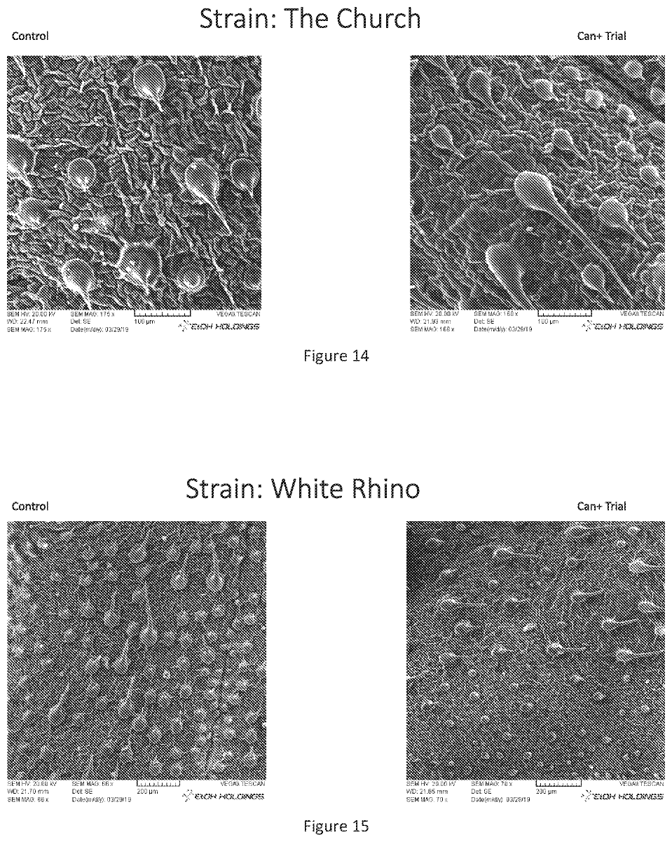

With reference to FIG. 14, for The Church, the trichomes of the control plant are in an earlier stage of development with rings at the base of the trichomes and hairs are thin. The trichomes of the treated plant are more bulbous and considerably larger and longer and thicker hairs. Again, it is noteworthy that the transplant date for the treated plant, versus the control plant, was 17 days apart, hence the control has had considerably more time to develop trichomes. The thickness of the cuticular wax in the treated plant is evident.

With reference to FIG. 15, for White Rhino, the bulbous shape of the trichomes of the treated plant is evident. It was also evident at sampling these specific plants that the control had started budding at least two weeks prior to the treated plant due to the difference in transplant times. White Rhino initiates flowering relatively rapidly after shifting photoperiod, hence this timing of transition from greenhouse to grow house in this experiment will mean that the real comparison should be of the final harvest. The more bulbous trichomes of the treated plant suggest a significantly higher THC yield at harvest. The well-developed cuticular wax in the treated plant versus much weaker cuticular wax in the control plant is noteworthy.

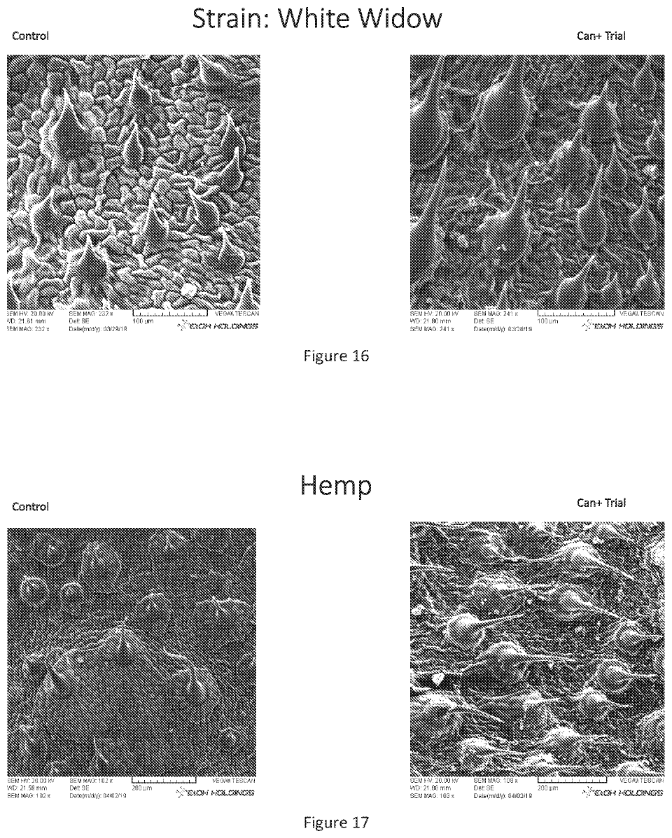

With reference to FIG. 16, for White Widow, a noticeable difference is visible in both the morphology and volume of the trichomes. Conservatively the trichomes are 30-40% greater in volume on the treated plant. Again, the more pronounced cuticle in the treated plant is noteworthy.

A hemp field trial in a mountainous area was also conducted. The hemp field trial plants planted directly in soil allowed different aspects of treatment with the stimulant composition of the disclosure to be demonstrated.

Field plants have deeper roots, more demanding growth conditions with stronger wind and lower temperatures at night and greater water stress with regards dry mountain air stripping moisture out of leaves during windy days.

Observations showed leaves of treated hemp plants were significantly more waxy and able to resist desiccation damage than control hemp plants. Treated plants left an oily residue on touch whereas control plants did not. With reference to FIG. 17, for hemp from a field trial, the SEM image of these leaves reveals aspects of how these differences are produced.

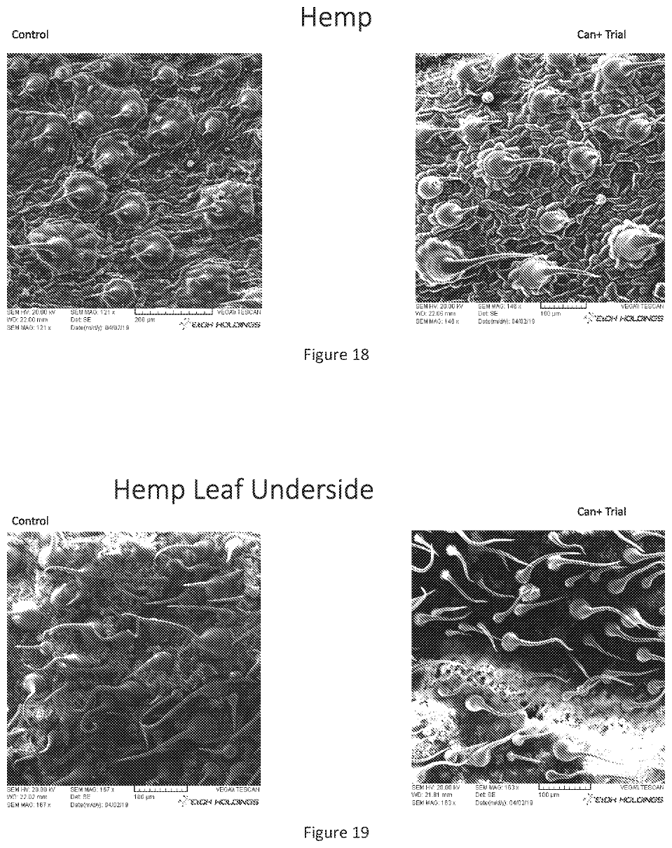

With reference to FIG. 18, for hemp, trichomes on the control hemp plant are generally smaller and thinner. Trichomes on treated hemp plants are larger, broader, longer, and more developed. This corresponds to a higher yield of extractable bioactive oils.

It can be concluded that the stimulant composition has enlarged the size of trichomes in cannabis strains analyzed. Under the growing conditions in this study, the stimulant composition of the disclosure has improved overall yields evident in trichome volumes by 30-40% in many cases at an early stage of growth.

Cannabis plants have trichomes on the upper and lower sides of the leaves. The lower side trichomes are of significance both as a source of the oils that make the plant medicinal, as well as for water conservation. In high mountain climates, and in greenhouse operations in such environments, the low atmospheric pressure, and low humidity, coupled with high temperatures can result in severe plant stress. In windy environments, similar stress can develop. Plants with well-developed under leaf trichomes will be more able to produce larger more marketable harvests.

With reference to FIG. 19, for hemp, the control plant appears to be infected with an unidentified surface growth. The treated plant did not exhibit such infections. In order to better understand this it is necessary to look at leaf transections.

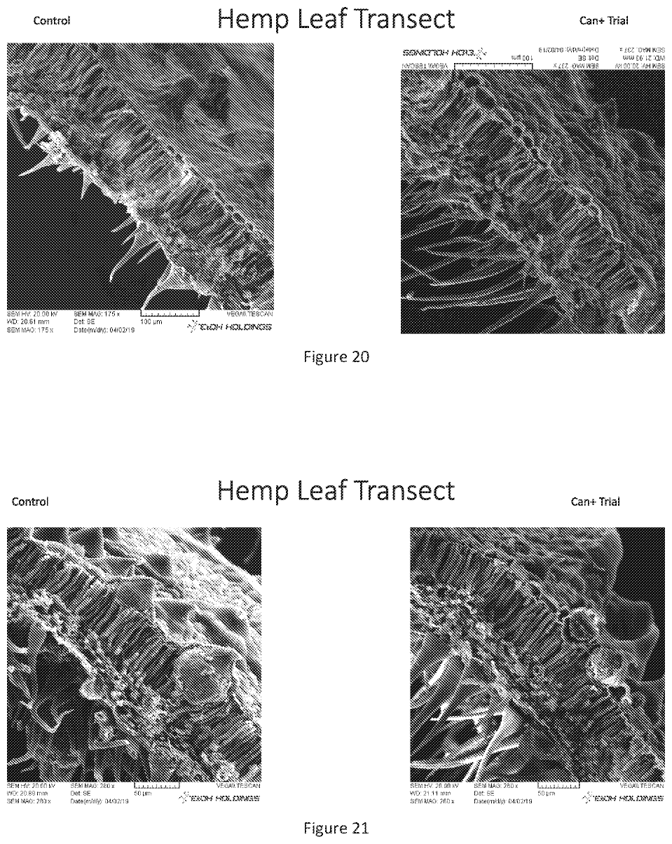

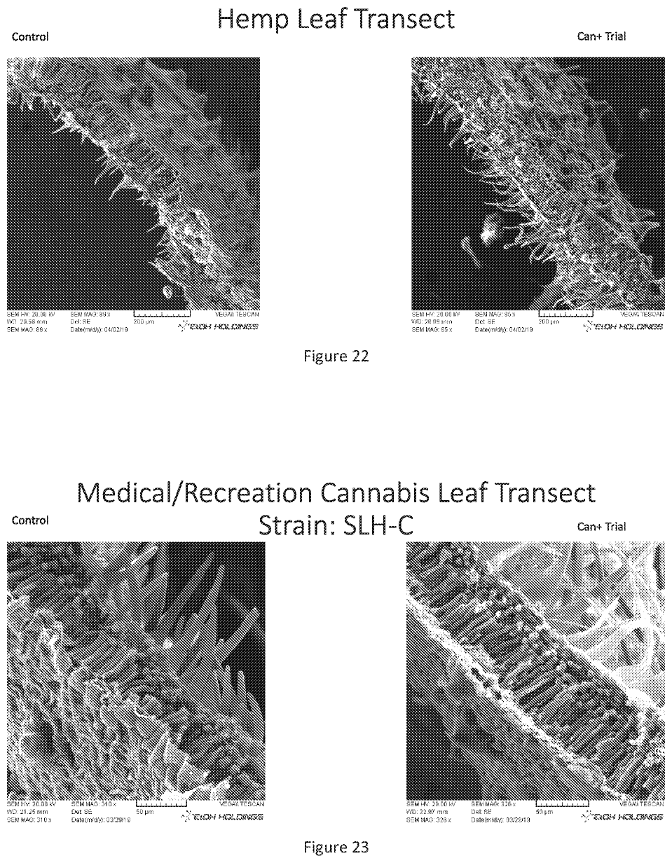

With reference to FIGS. 20-22, for hemp, it is evident that the leaf structure between the control plants and treated plants is different with more developed under leaf trichomes. The stimulant composition of the disclosure stimulates the production of both cannabinoids and terpenes in the trichomes, hence the healthier leaf structure is attributable to greater plant immunity to infection and damage. This is especially valuable in larger scale plantings as it will reduce the rate of development of infestation.

With reference to FIG. 23, for Super Lemon Haze C, both micrographs have the upper leaf on the lower part of the picture. Well developed under leaf trichomes are evident, with the treated plant showing considerably bushier and more developed under leaf hairs, much in line with what was seen in the hemp trials. These trichomes will exude and trap terpenes in the under leaf area, discouraging red spider mites and other pests.

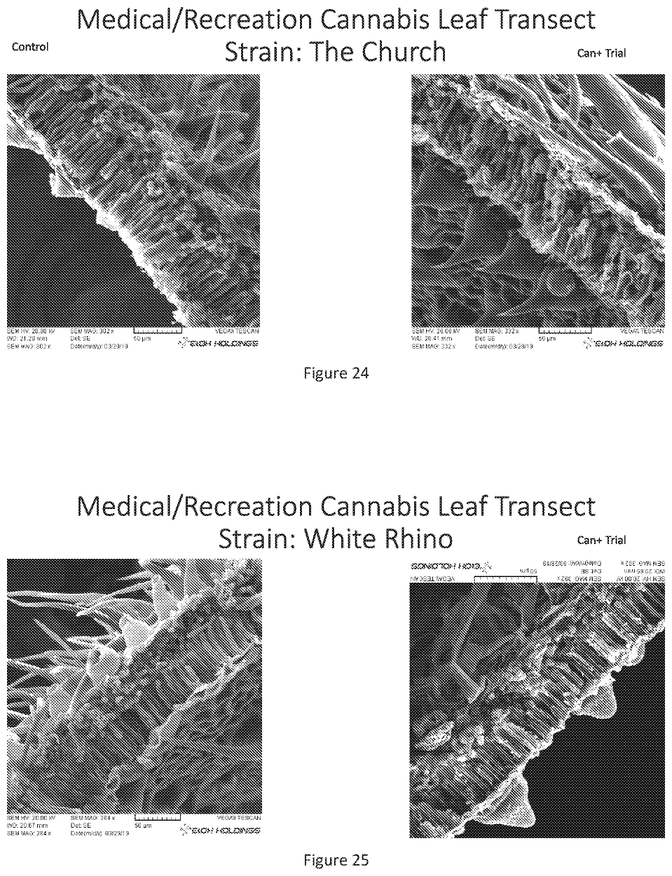

With reference to FIG. 24, for The Church, it is to be noted that in these SEM micrographs the upper leaf in both cases is at the lower corner of the image with the under leaf pointing upwards to the right. Much in line with the upper leaf surface trichome analysis earlier, the under leaf trichome/hair development is considerably more advanced in the treated plant than in the control plant. Similar to the Super Lemon Haze plants, the under leaf trichome development in The Church strain is more developed in the treated plant conferring greater water stress tolerance, disease tolerance, and yield to the treated plants.

With reference to FIG. 25, for White Rhino, much in line with the upper leaf trichome analysis, the under leaf trichomes in this strain are less developed in the treated plant. Again, it is important to highlight here that there is a considerable time delay of 17 days between the control and treated plants being placed under bud inducing light, hence the bud development in the treated plant is at an earlier stage. In this light, the comparable stage of development is significant given the two-week difference in development.

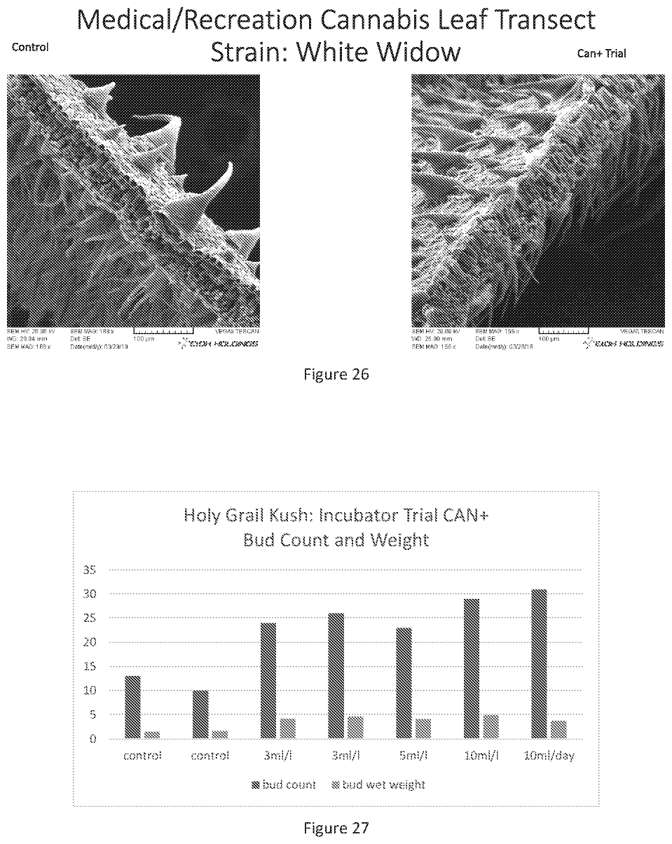

With reference to FIG. 26, for White Widow, the bulbous nature of the trichomes on the upper leaf in the treated plants are evident again. The leaf on the control is curved inwards and outwards in the trial, allowing one to see that the under leaf trichomes of the treated plant are actually much larger and longer than in the control.

It can be concluded that the stimulant composition of the disclosure has caused differences in leaf morphology in the strains analyzed. Trichome development on upper and lower leaves is generally different, with larger trichomes being the norm in treated plants. Leaf hairs are denser and hence will trap terpenes in the space under the leaf conferring improved resistance to pests such as spider mites, mites, and whitefly.

### Study 6

Seed of the Futura 75 hemp variety planted on 3 Jan. 2019 were harvested and dried when mature.

The majority of plants were grown without the stimulant composition of the disclosure, and a row of plants was grown with the stimulant composition added.

The stimulant composition of the disclosure has been shown to increase the yield of alkaloids and terpenes in indoor and outdoor experiments on cannabis plants and this study sought to confirm these data for the operating conditions of one of the commercial medical cannabis growers.

10 grams of dried product was macerated in a laboratory mill until powdered, and then placed in a 250 ml flask, with 100 ml distilled chloroform. Chloroform is an ideal solvent for analytical extraction of alkaloids in cannabis, but not for commercial extraction, as it is a toxic solvent. Given that these extracts were not for consumption, the use of chloroform was ideal for comparative purposes. Food grade solvents such as alcohol are far less scientifically exact as solvents but more suited to commercial extraction.

Samples were agitated for two hours, then filtered through a 5 micron filter to remove particulates. The samples were then submerged in a second 100 ml of predistilled chloroform to remove additional soluble components. After 2 hours these were filtered through 5 micron filters and the first and second extractions were combined and placed in a weighed flask. The flask was evaporated under vacuum until all chloroform had been removed and was weighed. The initial and final weight of the flask was used to calculate the extraction yield. The results are shown in Table 4.

TABLE 4

| | | Wet | Dry | | Extract in 10 | | Extract |
|---|---|---|---|---|---|---|---|
| Sample | Dosage of stimulant | Weight | Weight | % dry | grams dry | % | total |
| number | composition (ml/l) | (g) | (g) | weight | matter (g) | extract | (g) |
| 12 | 0 | 70 | 13 | 18.6 | 0.76 | 7.6 | 0.988 |
| 6 | 0 | 620 | 63 | 10.2 | 0.8 | 8 | 5.04 |
| 2 | 2.5 | 320 | 36 | 11.3 | 1.9 | 19 | 6.84 |
| 19 | 2.5 | 441 | 110 | 24.9 | 1.9 | 19 | 20.9 |

It is evident that the plants dosed with the stimulant composition of the disclosure both had a chloroform extractable component of 19% versus control plants which had a chloroform extractable component of 7.8% on average. This is a quite significant 244% increase in the percentage chloroform extractable component of the dry matter in the treated plants.

It is important to note that, although the dry weigh harvests were quite variable for both the control and the treated plants, the extractable components were not variable.

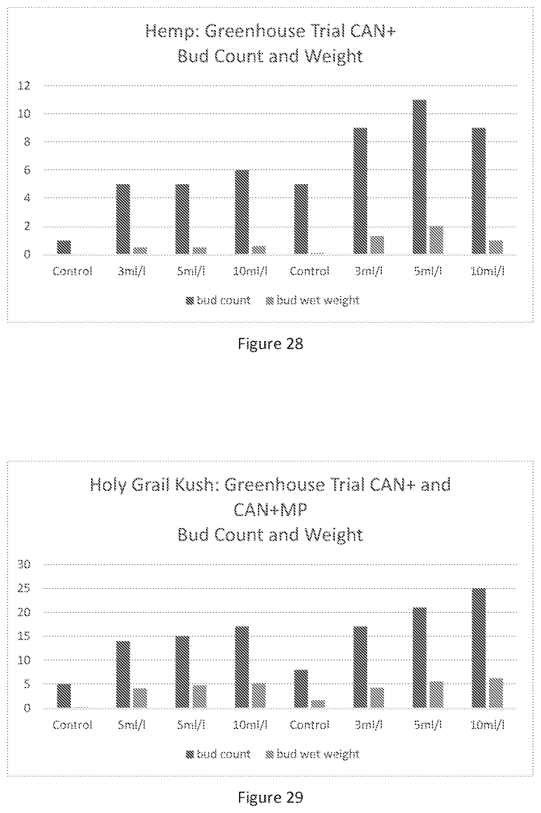

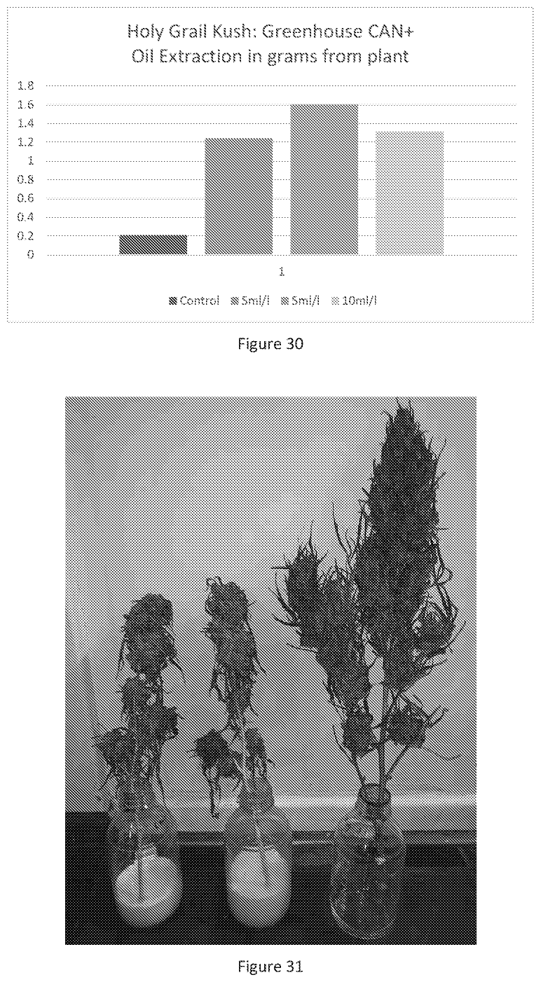

Follow-on research produced additional data set out in Table 5 and FIGS. 27 to 31. In Table 5 and the related Figures, HGK refers to the Holy Grail Kush strain, CAN+ refers to the stimulant composition of Study 1 without any added terpenes, CAN+T refers to the stimulant composition of Study 1 with added terpenes in a range of less than 1% by mass to about 3% by mass, and CAN+TMP refers to the stimulant composition of Study 1 with added terpenes from a Hehchrysum species in a range of less than 1% by mass to about 3% by mass.

TABLE 5

| Strain | | | | Bud wet | Oil | Oil % |
|---|---|---|---|---|---|---|
| or trial | | | | weight | extract | difference |
| identifier | Trial | | Bud count | (g) | (g) | over control |
| HGK 1 | control | | 13 | 1.5 | z | |
| HGK 2 | control | | 10 | 1.6 | z | |
| HGK 3 | 3 | ml/l | 24 | 4.2 | | |
| HGK 4 | 3 | ml/l | 26 | 4.6 | | |
| HGK 5 | 5 | ml/l | 23 | 4.1 | | |
| HGK 6 | 10 | ml/l | 29 | 4.9 | | |
| HGK 7 | 10 | ml/day | 31 | 3.7 | | |
| Hemp A | Control | | 1 | 0.01 | | |
| Hemp A | 3 | ml/l | 5 | 0.5 | | |
| Hemp A | 5 | ml/l | 5 | 0.5 | | |
| Hemp A | 10 | ml/l | 6 | 0.6 | | |
| Hemp B | Control | | 5 | 0.1 | | |
| Hemp B | 3 | ml/l | 9 | 1.3 | | |
| Hemp B | 5 | ml/l | 11 | 2 | | |
| Hemp B | 10 | ml/l | 9 | 1 | | |
| HGK CAN + T | Control | | 5 | 0.2 | 0.21 | 100.00 |
| HGK CAN + T | 5 | ml/l | 14 | 4.1 | 1.24 | 590.48 |
| HGK CAN + T | 5 | ml/l | 15 | 4.8 | 1.6 | 761.90 |
| HGK CAN + T | 10 | ml/l | 17 | 5.2 | 1.31 | 623.81 |
| HGK CAN + TMP | Control | | 8 | 1.61 | | |
| HGK CAN + TMP | 3 | ml/l | 17 | 4.3 | | |
| HGK CAN + TMP | 5 | ml/l | 21 | 5.6 | | |

Study 6, in combination with earlier studies, showed that the stimulant composition of the disclosure, even without added terpenes, caused increased levels of alkaloids in buds of treated plants. Extractable oil in hemp plants increased by 230%. The bud mass of hemp plants versus control plants increased significantly. The stimulant composition, even without added terpenes, stimulates dense cola development in plants, increasing bud density and thickness. The stimulant composition, even without added terpenes, stimulates bud development with treated plants having up to 3.1 times more buds than control plants. The stimulant composition, even without added terpenes, increases bud weight in plants with treated plants having up to 3.2 times greater bud mass. Bud development initiated in all treated plants earlier, with trichome development being two weeks earlier in treated plants versus controls. The stimulant composition, even without added terpenes, is able to deliver terpenes into cannabis plants, allowing their uptake through the roots. This causes a noted change in the bouquet and effects of buds produced. The stimulant composition, even without added terpenes, can hence be used to tailor a cannabis strain to increase certain flavor profiles and desired medicinal effects. Treated plants reach harvest more quickly, with buds maturing, and in certain strains yellowing, leading to a bud with high cannabinoids and low chlorophyll content, allowing quicker curing times. The stimulant composition, even without added terpenes, can be used as a postharvest soak on bud stalks to deliver terpenes into buds (see FIG. 31). This depigments the buds, creates a modified bouquet in the buds, and also bleaches the chlorophyll in the buds. The product is smooth when used in a vaporizer or in a combustion method of consumption. It is further hypothesized that the stimulant composition increased the number of mitochondria in secretory cells in the trichomes as well as increasing the size of the endoplasmic reticulum by up to 80%. Further transmission electron microscopy work will be necessary to confirm the hypothesis.

### Study 7

Further SEM work was done on the leaves of various strains of cannabis and hemp, 30 days after the SEM work reported in Study 5.

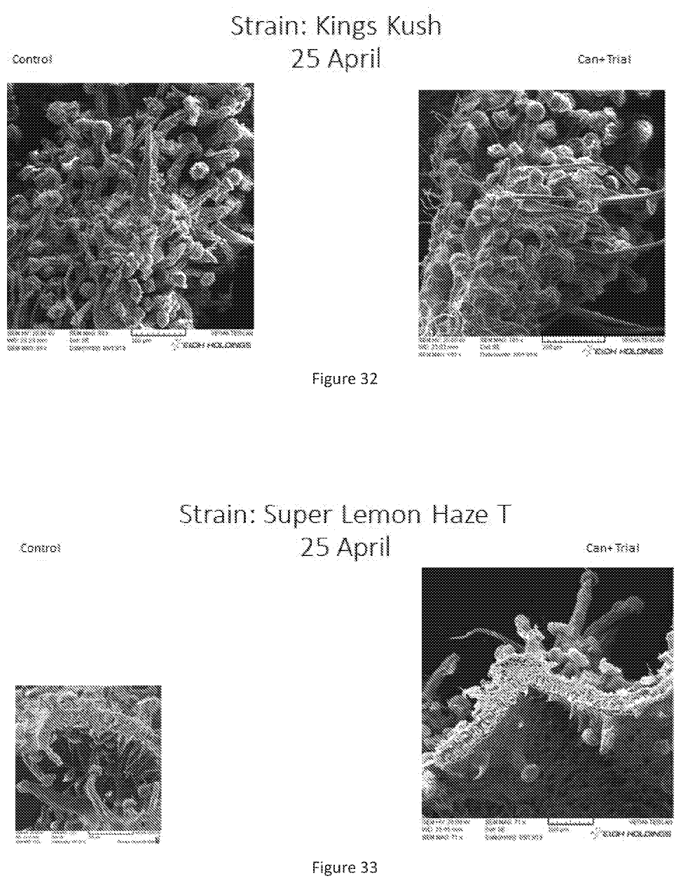

With reference to FIG. 32, for Kings Kush, the trichomes are well developed in both the treated and control samples, with bulbous, capitate sessile and capitate stalked trichomes evident in the treated sample and capitate sessile and capitate stalked trichomes evident in the control (two trichome types in control versus three in the treated sample). The treated sample has an overall more developed trichome mix, which will contribute a more complex alkaloid and terpene nature to the buds harvested, as the different trichome types each produce different sets of compounds.

With reference to FIG. 33, for Lemon Haze T, it is to be noted that the pictures are resized so that scale bars match. Of note is the significant difference in size between all trichomes in the treated plant versus the control plant. This explains the much higher yield of extractable oils observed in the treated plants, with trichome sizes being more than 50% larger in most cases. Also of note is that the heads on the capitate stalked trichome—which are rich in THC, are considerably better developed in the treated plant, corresponding to higher THC content measured on a Liquid Chromatography with Mass Spectroscopy (LC MS).

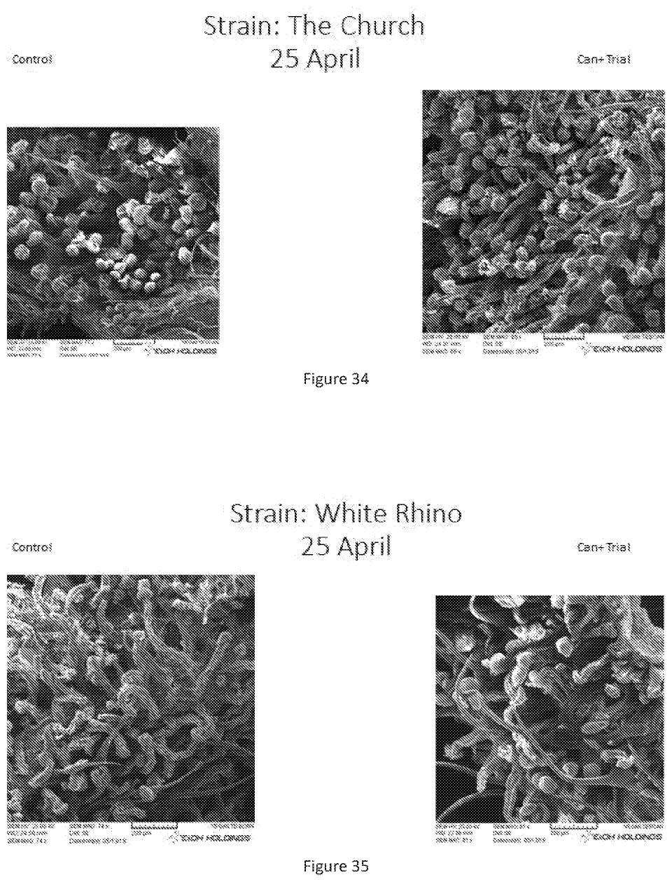

With reference to FIG. 34, for The Church, the trichomes of the treated plant are larger and better developed than that of the control plant. The stalks on capitate stalked and capitate sessile trichomes are longer and the heads of the stalked trichomes are wider and of greater volume corresponding to the improved yields of extractable oils found in the treated plants.

With reference to FIG. 35, for White Rhino, the trichomes visible in the treated plant are generally longer and thicker than the control. This corresponds to the greater extractable oil content seen in the treated plants analyzed. The waxy heads of the capitate stalked trichomes are significantly larger in the treated plant, and these are often rich in THC explaining higher THC levels measured in the treated plant.

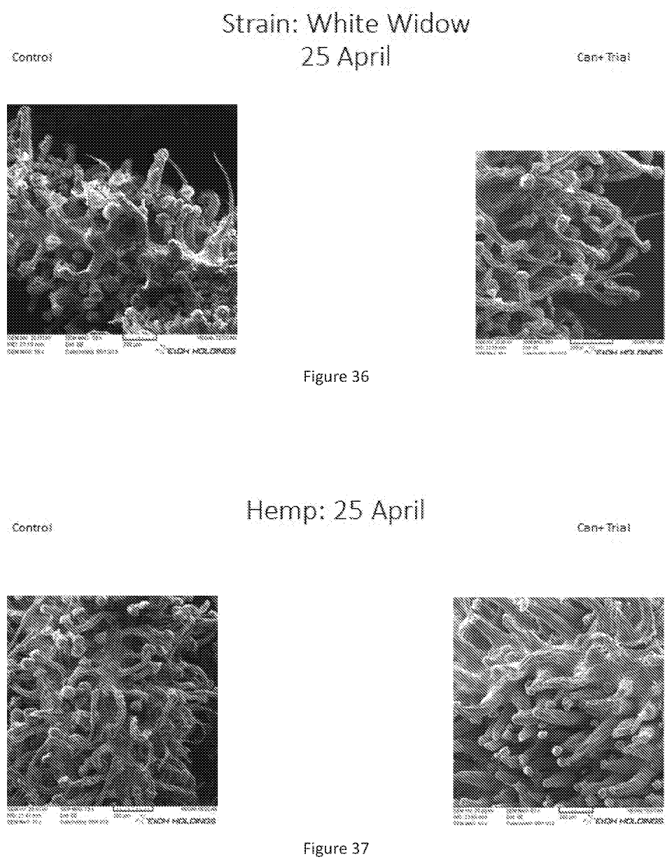

With reference to FIG. 36, for White Widow, treated plant in this case appears to have been slightly squashed hence the capitate stalked trichomes are a bit bent. Once this is corrected for, it is evident that these trichomes, together with the other trichomes evident are both larger and longer than the control plant trichomes. This corresponds to an increased oil yield, and significantly stronger terpene profile in treated plants noticed in this strain when preparing samples for analysis.

With reference to FIG. 37, for hemp, the increase in trichome size on the treated plant is significant. Unlike recreational high THC cannabis plants, where the THC is present in high concentrations in the bulbous tips of the capitate stalked trichomes, these hemp plants have very low THC levels and the bulbous tips are consequently much smaller.

### Study 8

Three popular strains of recreational cannabis were tested—Holy Grail Kush, Sex Wax, and Banana Dre Kush. Plants were cloned from mother plants of high quality grown from registered seeds. At transplant, plants were grown for approximately two months under indoor controlled lighting conditions.

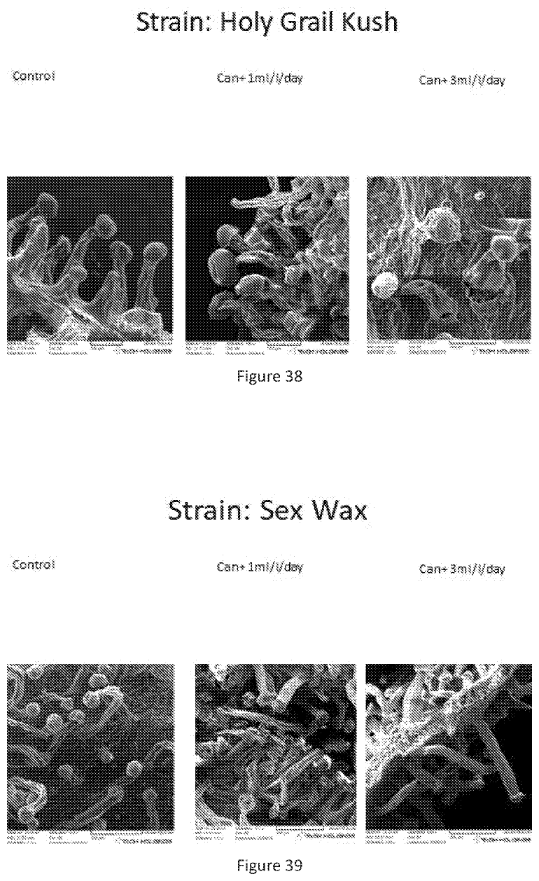

With reference to FIG. 38, for Holy Grail Kush, the addition of the stimulant composition to irrigation water in this trial in doses of either 1 m/l or 3 ml/l had the effect of increasing the size of the head of the capitate stalked trichomes. This corresponded to an increase in extractable oil content and an increase in cannabinoids, specifically THC.

With reference to FIG. 39, for Sex Wax, the trichomes in this strain are heavily influenced by treatment with the stimulant composition, with the trichome length increasing the most on the 1 ml/l/day treatment. Yields correspond to the trichome size as determined by total oil extraction and LC-MS.

The Banana Dre Kush trial was conducted with three clones of Banana Dre Kush, one control and two treated plants. The control plant died due to a mite infestation—the two treated plants did not. The treated plants, despite being in close proximity to the control plant, did not display signs of infection with the microscopic mites. The data is limited to the two treated plants.

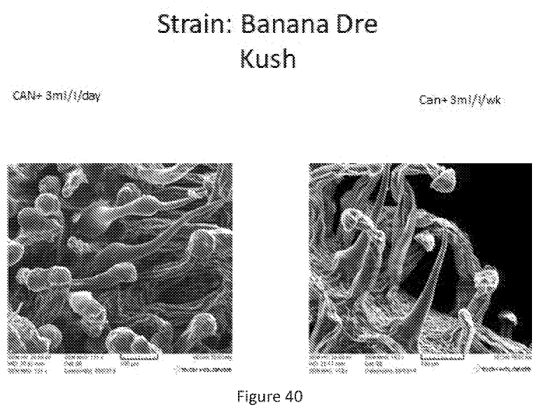

With reference to FIG. 40, for Banana Dre Kush, the trichomes in both of the treated plants were large with the 3 ml/l/day plant showing an unusual phenomenon in that some of the trichomes developed bulbous middles. This may be due to non-Newtonian fluid characteristics of certain of the cannabinoids, and the fact that the stimulant composition stimulates production beyond what the glands could easily exude, resulting in this higher volume hair structure.

Indoor grown cannabis is generally regarded as being of greater potency than outdoor grown cannabis. The trichome size and density displayed in plants grown indoors on the stimulant composition of the disclosure, without added terpene, are considerably larger than the control plants. Hence, the stimulant composition is able to increase yields of indoor plants even further.

### Study 9

A further oil extraction trial was conducted at a cannabis and hemp growing trial site in the Kingdom of Lesotho. To validate the initial oil extractions performed on four Futura 35 hemp samples obtained in Lesotho—two control plants and two treated plants—an additional set of oil extractions were performed as per the same method as set out in Study 6, with the results for hemp shown in Table 6.

TABLE 6

| Sample | | | % Oil |
|---|---|---|---|
| Number | Sample Description | Trial | in bud |
| 1 | Futura 75 C + D Indica | CONTROL | 8% |
| | Purple White, Batch 2 | | |
| 2 | Futura Hemp 75 B Indica White | CONTROL | 6% |
| 3 | Futura Hemp 75 C + D Indica | CONTROL | 4% |
| | Purple White Batch 2 | | |
| 4 | Futura Hemp 75 C Indica Purple | CONTROL | 8% |
| 5 | Futura Hemp 75 B Sativa White | CONTROL | 6% |
| 6 | Futura Hemp 75 B Sativa White | CONTROL | 9% |
| 7 | Futura Hemp 75 A Sativa Pink | CONTROL | 7% |
| 8 | Futura Hemp 75 D Indica White | CONTROL | 9% |
| 9 | Futura Hemp 75 C Indica Pink | CONTROL | 8% |

Hemp

| | | | |
|---|---|---|---|
| 11 | Futura Hemp 75 D Indica White | Stimulant | 13% |
| | | composition | |
| 12 | Futura Hemp 75 C Indica Purple | Stimulant | 11% |
| | | composition | |
| 13 | Futura Hemp 75 C Indica Purple | Stimulant | 12% |
| | | composition | |
| A | Futura Hemp 75 A Sativa Pink | Stimulant | 12% |
| | | composition | |
| B | B Sativa White | Stimulant | 20% |
| | | composition | |
| 16 | Futura Hemp 75 C Indica Purple | Stimulant | 15% |
| | | composition | |
| 17 | Futura Hemp 75 B Sativa White | Stimulant | 18% |
| | | composition | |
| 18 | Futura Hemp 75 A Sativa | Stimulant | 14% |
| | | composition | |
| 19 | Futura Hemp 75 B Sativa White | Stimulant | 13% |
| | | composition | |
| 20 | Futura Hemp 75 C Indica Purple | Stimulant | 13% |
| | | composition | |

Additional Samples

| | | | |
|---|---|---|---|
| A | Futura Hemp 75 A Sativa Pink | Stimulant | 12% |
| | | composition | |
| B | B Sativa White | Stimulant | 20% |
| | | composition | |
| C | A + B Sativa Purple White Pistol | CONTROL | 7% |
| D | Maluti Wildchild | Excess stimulant | 7% |
| | | composition | |
| E | LS01 | CONTROL | 12% |
| F | Futura Hemp 75 Control Net House | CONTROL | 8% |
| G | Futura Hemp 75 Net House CAN+ | Stimulant | 14% |
| | | composition | |
| H | Future Hemp 75 Control Net House | CONTROL | 6% |
| I | Future Hemp 75 net House CAN+ | Stimulant | 12% |
| | | composition | |
| J | Future Hemp 75 Control Net House | CONTROL | 10% |
| K | Maluti Outdoor Wild | CONTROL | 11% |

As is evident from Table 6, the addition of the stimulant composition of the disclosure, even without added terpene, to the growth operation increased oil contents significantly.

The oil extraction results for medical/recreation cannabis strains are shown in Table 7.

TABLE 7

| | | | % Oil |
|---|---|---|---|
| Sample Number | Sample Description | Trial | in bud |
| M2 | White Rhino | CONTROL | 11% |
| M3 | Super Lemon Haze T | CONTROL | 15% |
| M6 | Great White Shark | CONTROL | 5% |
| M7 | Kings Kush | CONTROL | 13% |
| M9 | The Church | CONTROL | 20% |
| M10 | Kings Kush | CONTROL | 21% |
| M14 | White Widow | CONTROL | 17% |
| M15 | White Widow | CONTROL | 20% |
| M16 | Super Lemon Haze C | CONTROL | 25% |
| M17 | White Widow | CONTROL | 18% |
| M18 | Kings Kush | CONTROL | 19% |
| M19 | Great White Shark | CONTROL | 10% |
| M1 | White Rhino | Stimulant | 26% |
| | | composition | |
| M4 | Super Lemon Haze T | Stimulant | 20% |
| | | composition | |
| M5 | Great White Shark | Stimulant | 18% |
| | | composition | |
| M8 | Kings Kush | Stimulant | 24% |
| | | composition | |
| M11 | White Widow | Stimulant | 32% |
| | | composition | |
| M12 | The Church | Stimulant | 30% |
| | | composition | |
| M13 | Super Lemon Haze C | Stimulant | 30% |
| | | composition | |

As is evident from the above table, the addition of the stimulant composition of the disclosure, even without added terpene, caused a significant increase in the percentage extractable oil in cannabis plants.

Cannabinoids in some of the samples were analyzed by LC-MS, with the results shown in Tables 8-18.

TABLE 8
White Rhino

| | | Stimulant |
|---|---|---|
| | Control | composition |
| THCs (THC, THCA, | 12.14 | 20.75 |
| DHC, DHCA) (%) | | |
| CBDs (CBD, CBDA) (%) | 0.51 | 0.63 |
| CBGs (CBG, CBGA) (%) | 0.92 | 1.63 |
| Other cannabinoids | 4.27 | 8.65 |
| (All others) (%) | | |
| Total Cannabinoids (%) | 17.84 | 31.66 |

From Table 8 it is clear that the treated White Rhino plant produced nearly twice as many cannabinoids as the control, with THC being significantly higher. This is a strain in which THC is desirable.

TABLE 9
Super Lemon Haze T

| | | | Stimulant |
|---|---|---|---|
| | | Simulant | composition |
| | Control | composition | used indoor |
| THCs (THC, THCA, | 15.75 | 13.34 | 15.51 |
| DHC, DHCA) (%) | | | |
| CBDs (CBD, CBDA) (%) | 0.55 | 0.49 | 0.50 |
| CBGs (CBG, CBGA) (%) | 1.39 | 1.14 | 0.92 |
| Other cannabinoids | 7.23 | 6.38 | 6.15 |
| (All others) (%) | | | |
| Total Cannabinoids (%) | 24.92 | 21.35 | 23.07 |

In this sample the CAN+ treated plants produced less cannabinoids than the control, although an indoor grown plant grown offsite produced values similar to the control, suggesting that the planting dates in this slow maturing strain may have had an effect.

TABLE 10
Great White Shark

| | | | Stimulant |
|---|---|---|---|
| | Control | Control | composition |
| THCs (THC, THCA, | 3.49 | 5.78 | 10.02 |
| DHC, DHCA) (%) | | | |
| CBDs (CBD, CBDA) (%) | 0.42 | 0.45 | 0.61 |
| CBGs (CBG, CBGA) (%) | 0.68 | 0.78 | 0.99 |
| Other cannabinoids | 2.85 | 3.25 | 6.00 |
| (All others) (%) | | | |
| Total Cannabinoids (%) | 7.45 | 10.26 | 17.62 |

This is a strain in which high THC is desirable. It is clear that the treated plant produced more of all cannabinoids compared to the control.

TABLE 11
Kings Kush

| | | | | Stimulant |
|---|---|---|---|---|
| | Control | Control | Control | composition |
| THCs (THC, THCA, | 11.08 | 9.80 | 9.76 | 8.30 |
| DHC, DHCA) (%) | | | | |
| CBDs (CBD, CBDA) (%) | 7.15 | 7.34 | 7.56 | 8.19 |
| CBGs (CBG, CBGA) (%) | 0.91 | 0.98 | 0.97 | 0.96 |
| Other cannabinoids | 4.86 | 4.71 | 3.81 | 6.90 |
| (All others) (%) | | | | |
| Total Cannabinoids (%) | 24.00 | 22.83 | 22.09 | 24.35 |

The treated plant in this experiment was considerably less mature than the control plants—hence, the treated plant has a higher overall cannabinoid content, but lower major cannabinoids due to these still being in the metabolic conversion process to the major cannabinoids. It is notable that despite being two weeks behind the control plants in growth, it exceeded the control in total cannabinoids. This is backed up by the total oil content extraction which showed a similar trend over the controls.

TABLE 12
The Church

| | | Stimulant |
|---|---|---|
| | Control | composition |
| THCs (THC, THCA, | 5.02 | 9.80 |
| DHC, DHCA) (%) | | |
| CBDs (CBD, CBDA) (%) | 5.72 | 6.15 |
| CBGs (CBG, CBGA) (%) | 1.02 | 1.18 |
| Other cannabinoids | 4.16 | 4.65 |
| (All others) (%) | | |
| Total Cannabinoids (%) | 15.92 | 21.77 |

Total cannabinoids for the treated plant in this strain exceeded the control plant significantly, with THC being much higher—a desirable trait in this recreational strain.

TABLE 13
White Widow

| | | | | Stimulant |
|---|---|---|---|---|
| | Control | Control | Control | composition |
| THCs (THC, THCA, | 14.06 | 15.25 | 11.39 | 21.02 |
| DHC, DHCA) (%) | | | | |
| CBDs (CBD, CBDA) (%) | 0.51 | 0.50 | 0.69 | 0.61 |
| CBGs (CBG, CBGA) (%) | 1.12 | 0.86 | 1.53 | 2.30 |
| Other cannabinoids | 3.51 | 3.43 | 4.25 | 5.31 |
| (All others) (%) | | | | |
| Total Cannabinoids (%) | 19.21 | 20.04 | 17.85 | 29.24 |

In this sample it is clear that the THC content of the treated plant is considerably higher than in the control plants—and more importantly, the CBG's are also considerably higher—many of these feed into the final synthesis of THC, hence a week later, when the plants were destined to be harvested the THC in the treated plant would have been even higher.

TABLE 14
Hemp

| | | Stimulant |
|---|---|---|
| | Control | composition |
| THCs (THC, THCA, | 0.75 | 0.95 |
| DHC, DHCA) (%) | | |
| CBDs (CBD, CBDA) (%) | 3.10 | 4.05 |
| CBGs (CBG, CBGA) (%) | 0.46 | 0.30 |
| Other cannabinoids | 2.67 | 2.67 |
| (All others) (%) | | |
| Total cannabinoids (%) | 6.99 | 7.97 |

The averaged data for 3 control plants and four test plants show a consistent increase in total cannabinoids and specifically the CBD family in treated plants, which are of commercial value in this strain in treated plants.

TABLE 15

| | Indoor | Indoor | Indoor |
|---|---|---|---|
| | Sex Wax | Sex Wax | Sex Wax |
| | Control | 1 ml/liter | 3 ml/liter |
| TCHs (THC, THCA, | 21.24 | 26.36 | 31.67 |
| DHC, DHCA) (%) | | | |
| CBDs (CBD, CBDA) (%) | 0.08 | 0.07 | 0.07 |
| CBGs (CBG, CBGA) (%) | 1.60 | 2.20 | 2.22 |
| Other cannabinoids | 1.57 | 2.05 | 7.34 |
| (All others) (%) | | | |

TABLE 16

| | Indoor grown | Indoor grown |
|---|---|---|
| | Banana Dre | Banana Dre 3 |
| | 3 ml/liter | ml/liter/week |
| THCs (THC, THCA, | 19.15 | 27.36 |
| DHC, DHCA) (%) | | |
| CBDs (CBD, CBDA) (%) | 0.07 | 0.07 |
| CBGs (CBG, CBGA) (%) | 0.00 | 0.26 |
| Other cannabinoids | 1.78 | 1.97 |
| (All others) (%) | | |

TABLE 17

| | Indoor | Indoor | Indoor |
|---|---|---|---|
| | grown Holy | grown Holy | grown Holy |
| | Grail Kush | Grail Kush | Grail Kush |
| | control | 1 ml/day | 3 ml/day |
| THCs (THC, THCA, | 28.47 | 33.61 | 31.67 |
| DHC, DHCA) (%) | | | |
| CBDs (CBD, CBDA) (%) | 0.07 | 0.07 | 0.07 |
| CBGs (CBG, CBGA) (%) | 0.00 | 0.35 | 0.59 |
| Other cannabinoids | 3.63 | 4.63 | 4.73 |
| (All others) (%) | | | |

It is apparent from the data in Tables 15 and 16 that the increasing dose of the stimulant composition corresponds to an increased concentration of cannabinoids in the plants. Specifically, THC shows increased concentrations.

TABLE 18

| | Outdoor | Outdoor | Outdoor | |
|---|---|---|---|---|
| | Killer from | Killer from | Killer from | |
| | Kuban Draw | Kuban Draw | Kuban Draw | |
| | Terpene A | Terpene B | Terpene C | Untreated |
| THCs (THC, THCA, | 24.86 | 23.81 | 17.84 | 20.21 |
| DHC, DHCA) (%) | | | | |
| CBDs (CBD, CBDA) (%) | 0.07 | 0.07 | 0.07 | 0.07 |
| CBGs (CBG, CBGA) (%) | 1.02 | 1.76 | 0.66 | 1.09 |
| Other cannabinoids | 2.06 | 2.93 | 2.07 | 2.26 |
| (All others) (%) | | | | |
| | 28.01 | 28.58 | 20.64 | 23.62 |

In draw experiments with branches of Killer from Kuban placed in solutions of the stimulant composition, the samples shown in Table 17 were obtained. It is evident that Terpenes A and B caused an increase in THC whereas Terpene C caused a decrease in THC. This demonstrates that the stimulant composition is capable of directly delivering terpenes into the cells in such a way that these disrupt and modify the outcomes of metabolic processes during the curing process.

### Study 10

Terpenes are compounds with strong odors. Their presence in cannabis buds improves the organoleptic properties of bud, and increases market price, as well as changing certain effects of the cannabis.

The stimulant composition of the disclosure was used to add terpenes to buds of the Killer from Kuban cannabis strain by harvesting stems and placing them in solutions of the stimulant composition with three different terpene rich essential oils, namely Rose Geranium, Sweet Basil, and Corn Mint oil. Buds were allowed to cure and were placed in 250 ml jars once cured and dry. Jars were given to subjects, who removed the lids and compared the nose of different jars to the control jar.

Table 19 summarizes the results.

TABLE 19

| | | | Rose | Sweet |
|---|---|---|---|---|
| | Control | Corn Mint | Geranium | Basil |
| Subject 1 | Strong Weed | Spearmint | Air freshener | Liquorice |
| Comments | | | | |
| Subject 2 | Citrus | Mint | Citrus rose | Strong, strange |
| Comments | | | | |
| Subject 3 | Marijuana | Mint | Smoky | Medicine |
| Comments | | | | |
| Subject 4 | Citrus/lemon | Peppermint | Weird | Liquorice |
| Comments | | | | |

The Killer from Kuban cannabis strain does have a natural citrus note to it, along with other terpenes. This was evident in 50% of the subjects detecting the citrus note in the control. The mint terpene is quite evident in Corn Mint buds, and is a simple, easy to distinguish terpene, whereas the combination of the Killer from Kuban subtle terpenes with Rose Geranium confused subjects, but the fact that it was different to the control shows that the effects were significant. The Sweet Basil oil had the strongest effect on the overall nose of the bud, but again, the Sweet Basil is a complex terpene in combination with the Killer from Kuban notes, hence the broad range of comments.

From the above it is possible to conclude that the terpenes absorbed by the cannabis plant stems were transported to the buds and had a direct impact on the organoleptic properties of the bud produced.

Observations have further shown that the stimulant composition, as exemplified, stimulates the direction of predatory mites to sites of plant injury. It is hypothesized that this is most likely through enhanced terpene content and hence enhanced signaling of plant damage to mites.

Although not wishing to be bound by theory, the inventors believe that the stimulant composition alters the ripening profile of the buds formed on the cannabis plants with ripe buds having lower chlorophyll content allowing for less complex processing of resultant oils to remove pigments.

The stimulant composition, as exemplified, applied as a foliar feed advantageously reduces the population of pests such as aphids, thrips, and whitefly amongst others. Pest resistance was found to be greater with both cannabis thrip and whitefly. It was noted that thrip presence on leaves of treated plants was up to 70% less, and in certain strains of medical/recreation cannabis heavy infestations of whitefly on adjacent non-cannabis plants, no whitefly were detectable on cannabis plants treated with the stimulant composition. Untreated plants developed severe whitefly problems.

The stimulant composition, as exemplified, applied in a hydroponic format, has the effect of encouraging early growth, allowing more rapid development of seedlings to the flowering cycle and hence a more rapid cycle from seed to harvest.

Advantageously, in aquaponics situations, the stimulant composition as exemplified has the effect of reducing the prevalence of fungal and bacterial ichthyo pathogens.

In the seedling stage the stimulant composition, as exemplified, has the effect of encouraging growth of beneficial soil microbes such as beneficial Trichoderma sp.

Enhanced cell wall stability and health of plants treated with the stimulant composition, as exemplified, are advantageously more easily cloned, allowing for rapid multiplication of desirable phenotypes.

The stimulant composition, as exemplified, is unusual in that it includes fatty alcohols, in combination with fatty acids, hydrocarbons, and preferably one or more terpenes, preferably also in combination with one or more phospholipids and one or more amino acids. The disclosure thus advantageously provides a stimulant composition comprising fatty acids, and related soluble and insoluble organic compounds formulated in such a way as to be emulsified in water which introduce precursory compounds comprising, in one embodiment, fatty acids, terpenes, lipids, sterols, phospholipids, and phenols into the various metabolic pathways which produce cannabinoids, terpenes, and cannabis phenolic compounds in such a way that the medicinal, recreational, and commercial value of the cannabis products produced is enhanced through higher contents of desirable biologically active compounds.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A stimulant composition to stimulate production of one or more cannabinoids by a plant producing such cannabinoids, the stimulant composition including
an optional diluent; and
a lipid portion or lipid composition which includes free or saponified fatty acids, free fatty alcohols, wax esters, hydrocarbons and at least one of a phospholipid and a terpene, the free fatty alcohols making up at least 5% by mass of the lipid portion or lipid composition and the at least one of a phospholipid, when present, making up at least 0.4% of the lipid portion or lipid composition, and the terpene, when present, making up at least 0.2% by mass of the lipid portion or lipid composition.

2. The stimulant composition according to claim 1, wherein the lipid portion or lipid composition includes one or more terpenes selected from the group consisting of myrcene, limonene, linalool, caryophyllene, alpha pinene, beta pinene, cineole, alpha bisabolol, trans nerolidol, humulene, camphene, borneol, terpineol, beta geraniol, geraniol, terpineol, and valencene.

3. The stimulant composition according to claim 1 or claim 2, wherein the one or more terpenes are present in the lipid portion or lipid composition in a concentration of at least 0.5% by mass or at least 1% by mass or at least 1.5% by mass and/or wherein the one or more terpenes are present in the lipid portion or lipid composition in a concentration of less than 4% by mass or less than 3% by mass or less than 2.5% by mass.

4. The stimulant composition according to any one of claims 1 to 3, wherein the free fatty alcohols are present in the lipid portion or lipid composition in a concentration of at least 8% by mass or at least 10% by mass or at least 12% by mass, and/or wherein the free fatty alcohols are present in the lipid portion or lipid composition in a concentration of less than 25% by mass or less than 22% by mass or less than 20% by mass.

5. The stimulant composition according to any one of claims 1 to 4, wherein the free fatty alcohols include fatty alcohols with a carbon number ranging between 24 and 32.

6. The stimulant composition according to any one of claims 1 to 5, wherein the free fatty alcohols include one or more alcohols selected from the group consisting of 1-octacosanol, 1-triacontanol, 1-tetracosanol, 1-dotriacontanol and 1-hexacosanol.

7. The stimulant composition according to any one of claims 1 to 6, wherein the lipid portion or lipid composition includes one or more phospholipids, the one or more phospholipids being present in the lipid portion or lipid composition in a concentration of at least 0.5% by mass or at least 0.6% by mass or at least 0.7% by mass, and/or wherein the one or more phospholipids are present in the lipid portion or lipid composition in a concentration of less than 1.2% by mass or less than 1.1% by mass or less than 1.0% by mass.

8. The stimulant composition according to any one of claims 1 to 7, wherein the fatty acids are present in the lipid portion or lipid composition in a concentration of at least 30% or at least 35% or at least 40% by mass, and/or wherein the fatty acids are present in the lipid portion or lipid composition in a concentration of less than 60% by mass or less than 55% by mass or less than 50% by mass.

9. The stimulant composition according to any one of claims 1 to 8, wherein the fatty acids include fatty acids with a carbon number ranging between 14 and 28.

10. The stimulant composition according to any one of claims 1 to 8, wherein the fatty acids include palmitic acid and lignoceric acid, the palmitic acid and the lignoceric acid in combination making up more than 50% by mass or more than 60%© by mass or more than 70% by mass of the fatty acids present in the lipid portion or lipid composition.

11. The stimulant composition according to claim 10, wherein the fatty acids include additionally one or more fatty acids selected from the group consisting of tetradecanoic acid, pentadecanoic acid, stearic acid, oleic acid, vaccenic acid, linoleic acid, alpha-linolenic acid, arachidic acid, dihomo-gamma-linolenic acid, eicosatrienoic acid, eicosatetraenoic acid, eicosapentaenoic acid, behenic acid, erucic acid, cerotic acid and montanic acid.

12. The stimulant composition according to any one of claims 1 to 11, wherein the hydrocarbons are present in the lipid portion or lipid composition in a concentration of at least 8% by mass or at least 10% by mass or at least 12% by mass, and/or wherein the hydrocarbons are present in the lipid portion or lipid composition in a concentration of less than 20% by mass or less than 18% by mass or less than 16% by mass.

13. The stimulant composition according to any one of claims 1 to 12, wherein the hydrocarbons include hydrocarbons with a carbon number ranging between 25 and 35.

14. The stimulant composition according to any one of claims 1 to 13, wherein the wax esters are present in the lipid portion or in the lipid composition in a concentration of at least 18% by mass or at least 20% by mass or at least 22% by mass, and/or wherein the wax esters are present in the lipid portion or in the lipid composition in a concentration of less than 34% by mass or less than 32% by mass or less than 30%© by mass.

15. The stimulant composition according to any one of claims 1 to 14, wherein the wax esters include wax esters with a carbon number ranging between 34 and 56.

16. The stimulant composition according to any one of claims 1 to 15, wherein the diluent is present and is water, and wherein the stimulant compositions in the form of an oil-in-water emulsion.

17. Use of the stimulant composition as claimed in any one of claims 1 to 16 to stimulate production of at least one cannabinoid in a plant producing said cannabinoid to promote increased yield of said at least one cannabinoid.

18. Use of the stimulant composition as claimed in any one of claims 1 to 16 to stimulate production of at least one terpene and/or at least one phenolic compound in a plant producing said terpene and/or said phenolic compound to promote increased yield of said at least one terpene and/or phenolic compound.

19. Use of the stimulant composition as claimed in any one of claims 1 to 16 to stimulate production of at least one bioactive compound other than a cannabinoid, terpene and phenolic compound, in a plant producing said bioactive compound to promote increased yield of said bioactive compound.

20. Use of a stimulant composition comprising free or saponified fatty acids, free fatty alcohols, wax esters and hydrocarbons, optionally at least one phospholipid, and optionally at least one terpene, to stimulate production of at least one of a cannabinoid, a terpene or a phenolic compound, in a plant producing a cannabinoid or a terpene or a phenolic compound.

21. A method of stimulating production of at least one cannabinoid in a plant producing said cannabinoid to promote increased yield of said at least one cannabinoid, the method including applying a stimulant composition that includes a lipid portion, or applying a lipid composition, to foliage of said plant or to soil or a growth medium in which said plant is growing, the stimulant composition, or the lipid portion of the stimulant composition, as the case may be, including free or saponified fatty acids, free fatty alcohols, wax esters and hydrocarbons.

22. The method according to claim 21, wherein the free fatty alcohols make up at least 5% by mass of the lipid composition or at least 5% by mass of the lipid portion of the stimulant composition.

23. The method according to claim 21 or claim 22, wherein the lipid composition or the lipid portion of the stimulant composition, as the case may be, includes one or more terpenes, and/or wherein the lipid composition or the lipid portion of the stimulant composition, as the case may be, includes one or more phospholipids.

24. The method according to claim 23, wherein the one or more phospholipids make up at least 0.4% by mass of the lipid portion or lipid composition and/or wherein the one or more terpenes make up at least 0.2% by mass of the lipid portion or lipid composition.

25. The method according to any one of claims 21 to 24, wherein the lipid composition is the same as, or corresponds to the lipid portion defined in any one of claims 1 to 16, or wherein the lipid portion is a lipid portion as defined in any one of claims 1 to 16, or wherein the stimulant composition is a stimulant composition according to any one of claims 1 to 16.

26. The method according to any one of claims 21 to 25, wherein the plant is Cannabis sp. or Cannabis sativa or Cannabis indica or a hybrid of Cannabis sativa and Cannabis indica, or hemp.

27. The method according to any one of claims 21 to 27, wherein the stimulant composition, or the lipid composition, is applied during the growth and flowering phases of plants to achieve the desired result of stimulating production of at least one cannabinoid in a plant producing said cannabinoid to promote increased yield of said at least one cannabinoid.

28. Use of a stimulant composition comprising free or saponified fatty acids, free fatty alcohols, wax esters and hydrocarbons, optionally at least one phospholipid, and optionally at least one terpene, to increase prevalence of root hairs and/or mycorrhizal growth in plants, and/or to increase the concentration of roots in an upper soil level, and/or to stimulate root growth, and/or to increase plant stem thickness and/or plant stem strength, and/or to increase branch tip cola development, and/or to stimulate development of thicker cuticles on leaves, and/or to increase leaf trichome size, and/or to increase alkaloid levels in buds, and/or to increase extractable oils, and/or to increase bud mass or bud density or thickness, and/or to provide earlier bud development, and/or to influence the flavor profile of buds, and/or to deliver terpenes into buds, and/or to cause plants to mature earlier, and/or to bleach chlorophyll from buds, and/or to increase pest resistance, in plants treated with the stimulant composition.
